(19) United States
(12) Patent Application Publication
(10) Pub. No.: US 2026/0238302 A1
(43) Pub. Date: Aug. 13, 2026

(54) ADAPTIVE CHANNEL STATE INFORMATION REPORTING FOR PREDICTIVE BEAM MANAGEMENT

(71) Applicant: QUALCOMM Incorporated, San Diego, CA (US)

(72) Inventors: Mohamed Fouad Ahmed MARZBAN, San Diego, CA (US); Qiaoyu LI, Beijing (CN); Mahmoud TAHERZADEH BOROUJENI, San Diego, CA (US); Hamed PEZESHKI, San Diego, CA (US)

(21) Appl. No.: 19/154,752

(22) PCT Filed: Feb. 22, 2024
(86) PCT No.: PCT/CN2024/078032

§ 371 Date: Aug. 7, 2025

(30) Foreign Application Priority Data
Apr. 5, 2023 (WO) PCT/CN2023/086354

(51) Int. Cl. H04B 7/06

(52) U.S. Cl. CPC H04B 7/06952; H04B 7/0626

(57) ABSTRACT

Methods, systems, and devices for wireless communication are disclosed. A user equipment (UE) may receive control information that indicates a confidence level threshold for beam reporting. The UE may receive a set of reference signals associated with a set of beams. The UE may transmit a report that indicates a subset of beam indices corresponding to a subset of the set of beams. The report may also indicate a corresponding confidence value for each of the subset of beam indices. The subset of confidence values may be indicative of a level of confidence in a predicted viability of the subset of the set of beams. The predicted viability may be based on measurements of the set of reference signals and a quantity of beam indices included in the subset of beam indices may be based on the subset of confidence values collectively satisfying the confidence level threshold.

### CROSS REFERENCE

The present application for patent is a 371 National Stage of PCT Application No. PCT/CN2024/078032, by MARZBAN et al., entitled “ADAPTIVE CHANNEL STATE INFORMATION REPORTING FOR PREDICTIVE BEAM MANAGEMENT,” filed Feb. 22, 2024, which claims the benefit of International Patent Application No. PCT/CN2023/086354 by MARZBAN et al., entitled “ADAPTIVE CHANNEL STATE INFORMATION REPORTING FOR PREDICTIVE BEAM MANAGEMENT,” filed Apr. 5, 2023, each of which is assigned to the assignee hereof, and each of which is expressly incorporated by reference herein.

### FIELD OF TECHNOLOGY

The following relates to wireless communication, including adaptive channel state information (CSI) reporting for predictive beam management.

### BACKGROUND

Wireless communications systems are widely deployed to provide various types of communication content such as voice, video, packet data, messaging, broadcast, and so on. These systems may be capable of supporting communication with multiple users by sharing the available system resources (e.g., time, frequency, and power). Examples of such multiple-access systems include fourth generation (4G) systems such as Long Term Evolution (LTE) systems, LTE-Advanced (LTE-A) systems, or LTE-A Pro systems, and fifth generation (5G) systems which may be referred to as New Radio (NR) systems. These systems may employ technologies such as code division multiple access (CDMA), time division multiple access (TDMA), frequency division multiple access (FDMA), orthogonal FDMA (OFDMA), or discrete Fourier transform spread orthogonal frequency division multiplexing (DFT-S-OFDM).

A wireless multiple-access communications system may include one or more network entities, each supporting wireless communication for communication devices, which may be known as user equipment (UE). Some wireless communications systems may support a format for channel state information (CSI) reporting in which a UE may report parameters associated with an estimated communication channel to a network entity. The network entity may use the reported parameters to improve the capacity of the channel through adaptive techniques, such as channel precoding, interference mitigation, and signal rank determination. In some cases, existing techniques for CSI reporting could be improved.

### SUMMARY

The described techniques relate to improved methods, systems, devices, and apparatuses that support adaptive channel state information (CSI) reporting for predictive beam management. For example, the described techniques provide a framework for reporting a variable quantity of beams while still using a report having a fixed size. In some examples, a user equipment (UE) may receive control information from a network entity. The control information may indicate a confidence level threshold for beam reporting. The UE may also receive a set of reference signals from the network entity. The set of reference signals may be associated with a set of beams used for wireless communication at the network entity. For example, each beam of the set of beams may correspond to a respective beam index. The UE may transmit a report to the network entity. The report may indicate a subset of beam indices corresponding to a subset of the set of beams. The report may also indicate a corresponding confidence value for each of the subset of beam indices. In some examples, the subset of confidence values may be indicative of a level of confidence in a predicted viability of the subset of the set of beams. The predicted viability may be based on one or more measurements of the set of reference signals and a quantity of beam indices included in the subset of beam indices may be based on the subset of confidence values collectively satisfying the confidence level threshold.

A method for wireless communication by a UE is described. The method may include receiving, from a network entity, control information that indicates a confidence level threshold for beam reporting, receiving, from the network entity, a set of reference signals associated with a set of beams used for wireless communication at the network entity, where each beam of the set of beams corresponds to a respective beam index, and transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

A UE is described. The UE may include one or more memories storing processor-executable code, and one or more processors coupled with the one or more memories. The one or more processors may be individually or collectively operable to execute the code to cause the UE to receive, from a network entity, control information that indicates a confidence level threshold for beam reporting, receive, from the network entity, a set of reference signals associated with a set of beams used for wireless communication at the network entity, where each beam of the set of beams corresponds to a respective beam index, and transmit, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

Another UE is described. The UE may include means for receiving, from a network entity, control information that indicates a confidence level threshold for beam reporting, means for receiving, from the network entity, a set of reference signals associated with a set of beams used for wireless communication at the network entity, where each beam of the set of beams corresponds to a respective beam index, and means for transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

A non-transitory computer-readable medium storing code for wireless communication is described. The code may include instructions executable by one or more processors to receive, from a network entity, control information that indicates a confidence level threshold for beam reporting, receive, from the network entity, a set of reference signals associated with a set of beams used for wireless communication at the network entity, where each beam of the set of beams corresponds to a respective beam index, and transmit, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

In some examples of the method, UEs, and non-transitory computer-readable medium described herein, communicating, with the network entity, an indication of an update for at least one parameter associated with the report based on the quantity of beam indices included in the subset of beam indices for the report being different from a previous quantity of beam indices included in the subset of beam indices for a previous report.

In some examples of the method, UEs, and non-transitory computer-readable medium described herein, communicating the indication may include operations, features, means, or instructions for transmitting, to the network entity, the indication of the update for the at least one parameter, the indication being included with the report and in a medium access control-control element (MAC-CE) or an uplink control information (UCI).

In some examples of the method, UEs, and non-transitory computer-readable medium described herein, communicating the indication may include operations, features, means, or instructions for receiving, from the network entity, the indication of the update for the at least one parameter, the indication being included in a MAC-CE or a downlink control information (DCI).

Some examples of the method, UEs, and non-transitory computer-readable medium described herein may further include operations, features, means, or instructions for transmitting, to the network entity, a recommendation for the update of the at least one parameter, where the update may be based on the recommendation.

In some examples of the method, UEs, and non-transitory computer-readable medium described herein, the at least one parameter includes a payload size, a payload structure, a report quantization level, a threshold quantity of beam indices, or any combination thereof.

In some examples of the method, UEs, and non-transitory computer-readable medium described herein, a quantization level used to indicate the subset of beam indices and the corresponding confidence value for each of the subset of beam indices may be variable and may be based on the quantity of beam indices included in the subset of beam indices.

In some examples of the method, UEs, and non-transitory computer-readable medium described herein, the quantity of beam indices included in the report may be less than a total quantity of the subset of confidence values collectively satisfying the confidence level threshold and a remainder of the total quantity not included in the report may be included in a MAC-CE.

In some examples of the method, UEs, and non-transitory computer-readable medium described herein, the confidence values included in the report may be greater in value than the confidence values for each of the remainder of the total quantity not included in the report.

In some examples of the method, UEs, and non-transitory computer-readable medium described herein, the quantity of beam indices included in the report may be less than a total quantity of the subset of confidence values collectively satisfying the confidence level threshold and a remainder of the total quantity not included in the report may be not transmitted.

In some examples of the method, UEs, and non-transitory computer-readable medium described herein, the report includes a set of multiple fields for indicating the subset of beam indices and content of at least one field of the set of multiple fields indicates a null value based on the quantity of beam indices included in the subset of beam indices being less than a threshold quantity of beam indices associated with the report.

In some examples of the method, UEs, and non-transitory computer-readable medium described herein, the report indicates a quantity of beams associated with the report.

Some examples of the method, UEs, non-transitory computer-readable medium described herein may further include operations, features, means, or instructions for transmitting, to the network entity, an indication of an update for at least one parameter associated with the report based on a quantity of beam indices expected to be included in the subset of beam indices for a future report being different from the quantity of beam indices included in the subset of beam indices for the report.

In some examples of the method, UEs, and non-transitory computer-readable medium described herein, transmitting the indication may include operations, features, means, or instructions for transmitting, in a first part of the report, the indication of the update for the at least one parameter and transmitting, in a second part of the report, information that indicates the subset of beam indices and the corresponding confidence value for each of the subset of beam indices.

In some examples of the method, UEs, and non-transitory computer-readable medium described herein, the report indicates a corresponding received power metric for each of the subset of beam indices, the subset of received power metrics based on one or more measurements of a subset the set of reference signals associated with the subset of the set of beams.

A method for wireless communication by a network entity is described. The method may include outputting control information that indicates a confidence level threshold for beam reporting, outputting a set of reference signals associated with a set of beams used for wireless communication at the network entity, where each beam of the set of beams corresponds to a respective beam index, and obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

A network entity is described. The network entity may include one or more memories storing processor-executable code, and one or more processors coupled with the one or more memories. The one or more processors may be individually or collectively operable to execute the code to cause the network entity to output control information that indicates a confidence level threshold for beam reporting, output a set of reference signals associated with a set of beams used for wireless communication at the network entity, where each beam of the set of beams corresponds to a respective beam index, and obtain a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

Another network entity is described. The network entity may include means for outputting control information that indicates a confidence level threshold for beam reporting, means for outputting a set of reference signals associated with a set of beams used for wireless communication at the network entity, where each beam of the set of beams corresponds to a respective beam index, and means for obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

A non-transitory computer-readable medium storing code for wireless communication is described. The code may include instructions executable by one or more processors to output control information that indicates a confidence level threshold for beam reporting, output a set of reference signals associated with a set of beams used for wireless communication at the network entity, where each beam of the set of beams corresponds to a respective beam index, and obtain a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

Some examples of the method, network entities, and non-transitory computer-readable medium described herein may further include operations, features, means, or instructions for communicating an indication of an update for at least one parameter associated with the report based on the quantity of beam indices included in the subset of beam indices for the report being different from a previous quantity of beam indices included in the subset of beam indices for a previous report.

In some examples of the method, network entities, and non-transitory computer-readable medium described herein, communicating the indication may include operations, features, means, or instructions for obtaining the indication of the update for the at least one parameter, the indication being included with the report and in a MAC-CE or a UCI.

In some examples of the method, network entities, and non-transitory computer-readable medium described herein, communicating the indication may include operations, features, means, or instructions for outputting the indication of the update for the at least one parameter, the indication being included in a MAC-CE or a DCI.

Some examples of the method, network entities, and non-transitory computer-readable medium described herein may further include operations, features, means, or instructions for obtaining a recommendation for the update of the at least one parameter, where the update may be based on the recommendation.

In some examples of the method, network entities, and non-transitory computer-readable medium described herein, the at least one parameter includes a payload size, a payload structure, a report quantization level, a threshold quantity of beam indices, or any combination thereof.

In some examples of the method, network entities, and non-transitory computer-readable medium described herein, a quantization level used to indicate the subset of beam indices and the corresponding confidence value for each of the subset of beam indices may be variable and may be based on the quantity of beam indices included in the subset of beam indices.

In some examples of the method, network entities, and non-transitory computer-readable medium described herein, the quantity of beam indices included in the report may be less than a total quantity of the subset of confidence values collectively satisfying the confidence level threshold and a remainder of the total quantity not included in the report may be included in a MAC-CE.

In some examples of the method, network entities, and non-transitory computer-readable medium described herein, the confidence values included in the report may be greater in value than the confidence values for each of the remainder of the total quantity not included in the report.

In some examples of the method, network entities, and non-transitory computer-readable medium described herein, the quantity of beam indices included in the report may be less than a total quantity of the subset of confidence values collectively satisfying the confidence level threshold and a remainder of the total quantity not included in the report may be not transmitted.

In some examples of the method, network entities, and non-transitory computer-readable medium described herein, the report includes a set of multiple fields for indicating the subset of beam indices and content of at least one field of the set of multiple fields indicates a null value based on the quantity of beam indices included in the subset of beam indices being less than a threshold quantity of beam indices associated with the report.

In some examples of the method, network entities, and non-transitory computer-readable medium described herein, the report indicates a quantity of beams associated with the report.

Some examples of the method, network entities, and non-transitory computer-readable medium described herein may further include operations, features, means, or instructions for obtaining an indication of an update for at least one parameter associated with the report based on a quantity of beam indices expected to be included in the subset of beam indices for a future report being different from the quantity of beam indices included in the subset of beam indices for the report.

In some examples of the method, network entities, and non-transitory computer-readable medium described herein, obtaining the indication may include operations, features, means, or instructions for obtaining, in a first part of the report, the indication of the update for the at least one parameter and obtaining, in a second part of the report, information that indicates the subset of beam indices and the corresponding confidence value for each of the subset of beam indices.

In some examples of the method, network entities, and non-transitory computer-readable medium described herein, the report indicates a corresponding received power metric for each of the subset of beam indices, the subset of received power metrics based on one or more measurements of a subset the set of reference signals associated with the subset of the set of beams.

### BRIEF DESCRIPTION OF THE DRAWINGS

FIGS. 1 and 2 each show an example of a wireless communications system that supports adaptive channel state information (CSI) reporting for predictive beam management in accordance with one or more aspects of the present disclosure.

FIGS. 3A and 3B each show an example of a beam prediction diagram that supports adaptive CSI reporting for predictive beam management in accordance with one or more aspects of the present disclosure.

FIG. 4 shows an example of a timing diagram that supports adaptive CSI reporting for predictive beam management in accordance with one or more aspects of the present disclosure.

FIG. 5 shows an example of a process flow that supports adaptive CSI reporting for predictive beam management in accordance with one or more aspects of the present disclosure.

FIGS. 6 and 7 show block diagrams of devices that support adaptive CSI reporting for predictive beam management in accordance with one or more aspects of the present disclosure.

FIG. 8 shows a block diagram of a communications manager that supports adaptive CSI reporting for predictive beam management in accordance with one or more aspects of the present disclosure.

FIG. 9 shows a diagram of a system including a device that supports adaptive CSI reporting for predictive beam management in accordance with one or more aspects of the present disclosure.

FIGS. 10 and 11 show block diagrams of devices that support adaptive CSI reporting for predictive beam management in accordance with one or more aspects of the present disclosure.

FIG. 12 shows a block diagram of a communications manager that supports adaptive CSI reporting for predictive beam management in accordance with one or more aspects of the present disclosure.

FIG. 13 shows a diagram of a system including a device that supports adaptive CSI reporting for predictive beam management in accordance with one or more aspects of the present disclosure.

FIGS. 14 and 15 show flowcharts illustrating methods that support adaptive CSI reporting for predictive beam management in accordance with one or more aspects of the present disclosure.

### DETAILED DESCRIPTION

A wireless communications system may support one or more predictive beam management techniques in which a communication device (e.g., a user equipment (UE), a network entity) may use artificial intelligence (AI) for beam predictions. For example, the network entity may use a set of downlink beams to transmit a set of reference signals to the UE. The UE may use AI to predict and report (e.g., via a channel state information (CSI) report) which of the set of downlink beams correspond to a top beam based on measurements performed at the UE on the set of reference signals. A top beam may refer to a beam predicted to have a highest beam quality or a highest signal strength relative to other detectable beams. That is, the top beam may correspond to a most viable beam for downlink communications between the UE and the network entity. In some examples, use of AI to predict the top beam may enable the UE to determine (and report) a confidence value associated with the prediction. For example, the UE may use AI to predict a viability of a downlink beam and obtain a level of confidence in the predicted viability. Accordingly, the UE may report a beam index and a corresponding confidence value (e.g., indicative of the level of confidence in the predicted viability) of the downlink beam to the network for beam management. In some examples, the UE may report a respective beam index and corresponding confidence value for multiple downlink beams. In some examples, however, reporting confidence values for multiple downlink beams may lead to increased signaling overhead associated with CSI reporting.

In some examples, to reduce overhead, the UE may report a beam index and corresponding confidence value for a single downlink beam (e.g., the downlink beam with the highest confidence value among confidence values obtained for the set of downlink beams). In some cases, however, confidence values associated with multiple downlink beams may be relatively similar and reporting a single downlink beam may degrade a performance of beam management at the network entity. In some other examples, the UE may report beam indices for a variable quantity of downlink beams. For example, the UE may support variable beam reporting in which the UE may transmit a CSI report that indicates a quantity of beam indices (and corresponding confidence values) based on a confidence threshold. The quantity of beam indices indicated via the CSI report may be based on the corresponding quantity of confidence values satisfying the confidence threshold. In some cases, however, a confidence value obtained for a downlink beam may vary across multiple CSI reports and, accordingly, the quantity confidence values that satisfy the confidence threshold may also vary across the multiple CSI reports. In some examples, because the quantity of confidence values that satisfy the confidence threshold may vary across multiple CSI reports, the quantity of reported beam indices (and corresponding confidence values) may also vary across the multiple CSI reports. In some examples, the quantity of reported beam indices (and corresponding confidence values) varying across multiple CSI reports may lead to ambiguity in a payload size of the CSI reports, which may impact decoding of the CSI reports at the network entity. In some examples, the UE may transmit multiple CSI reports in which a first CSI report indicates a quantity of beam indices (and corresponding confidence values) to be reported in a second CSI report. However, using multiple CSI reports to indicate a variable quantity of beam indices may lead to increased signaling overhead associated with CSI reporting.

Various aspects of the present disclosure relate to techniques for adaptive CSI reporting for predictive beam management and, more specifically, to a framework for reporting a variable quantity of beams using a single CSI report per reporting occasion. For example, the UE may receive control information that may indicate a confidence threshold for beam reporting. The UE may also receive a set of reference from the network entity. For example, the network entity may use a set of downlink beams to transmit the set of reference signals to the UE. Accordingly, the set of reference signals may be associated with the set of downlink beams (e.g., each reference signal may be associated with a respective one of the downlink beams). The UE may transmit a CSI report to the network entity, which may indicate a subset of beam indices corresponding to a subset of the set of downlink beams. The CSI report may also indicate a corresponding confidence value for each beam index of the subset of beam indices. The subset of confidence values may be indicative of a level of confidence in a predicted viability of the subset of the set of beams. The predicted viability may be based on one or more measurements of the set of reference signals and a quantity of beam indices included in the subset of beam indices may be based on the subset of confidence values collectively satisfying the confidence threshold. In some examples, a payload associated with the CSI report may be insufficient to report the quantity of beam indices included in the subset of beam indices. In such an example, the UE or the network entity (or both) may update one or more other parameters associated with the CSI report, such that the CSI report may accommodate the quantity of beam indices included in the subset of beam indices. For example, the UE or the network entity may update a payload size of the CSI report, a payload structure of the CSI report, a report quantization level, or a threshold quantity of beam indices to be indicated via the CSI report, or any combination thereof.

Aspects of the subject matter described herein may be implemented to realize one or more of the following potential advantages. For example, the techniques employed by the described communication devices may provide benefits and enhancements to the operation of the communication devices, including reduced overhead associated with CSI reporting. The operations performed by the described communication devices to reduce overhead for CSI reporting may include configuring a UE with a confidence level threshold for beam reporting. In some examples, operations performed by the described communication devices may also support increased reliability of communications within a wireless communications system, among other benefits.

Aspects of the disclosure are initially described in the context of wireless communications systems. Aspects of the disclosure are also described in the context of beam prediction diagrams, a timing diagram, and a process flow. Aspects of the disclosure are further illustrated by and described with reference to apparatus diagrams, system diagrams, and flowcharts that relate to adaptive CSI reporting for predictive beam management.

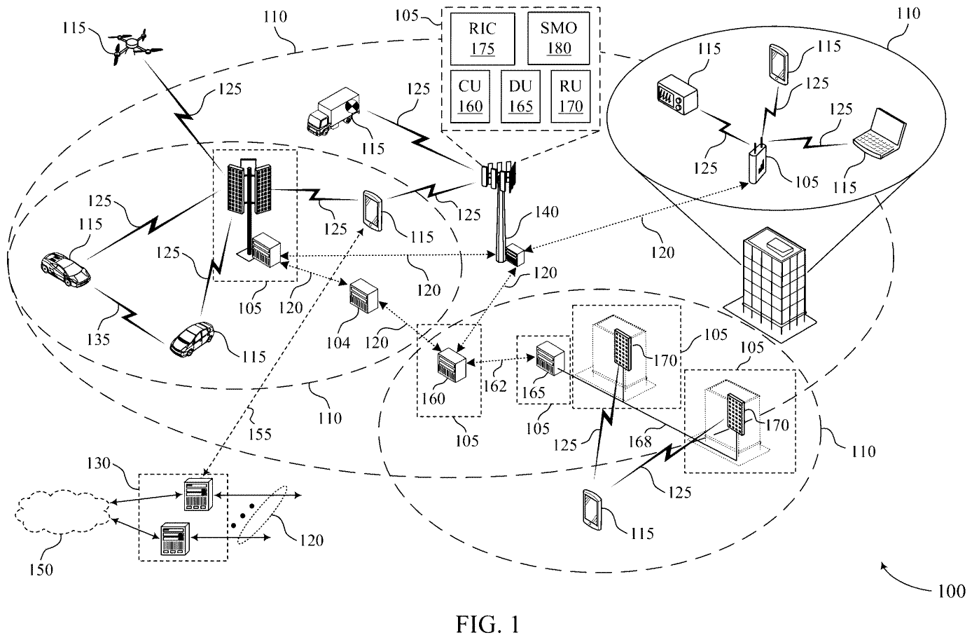

FIG. 1 shows an example of a wireless communications system 100 that supports adaptive CSI reporting for predictive beam management in accordance with one or more aspects of the present disclosure. The wireless communications system 100 may include one or more network entities 105, one or more UEs 115, and a core network 130. In some examples, the wireless communications system 100 may be a Long Term Evolution (LTE) network, an LTE-Advanced (LTE-A) network, an LTE-A Pro network, a New Radio (NR) network, or a network operating in accordance with other systems and radio technologies, including future systems and radio technologies not explicitly mentioned herein.

The network entities 105 may be dispersed throughout a geographic area to form the wireless communications system 100 and may include devices in different forms or having different capabilities. In various examples, a network entity 105 may be referred to as a network element, a mobility element, a radio access network (RAN) node, or network equipment, among other nomenclature. In some examples, network entities 105 and UEs 115 may wirelessly communicate via one or more communication links 125 (e.g., a radio frequency (RF) access link). For example, a network entity 105 may support a coverage area 110 (e.g., a geographic coverage area) over which the UEs 115 and the network entity 105 may establish one or more communication links 125. The coverage area 110 may be an example of a geographic area over which a network entity 105 and a UE 115 may support the communication of signals according to one or more radio access technologies (RATs).

The UEs 115 may be dispersed throughout a coverage area 110 of the wireless communications system 100, and each UE 115 may be stationary, or mobile, or both at different times. The UEs 115 may be devices in different forms or having different capabilities. Some example UEs 115 are illustrated in FIG. 1. The UEs 115 described herein may be capable of supporting communications with various types of devices, such as other UEs 115 or network entities 105, as shown in FIG. 1.

As described herein, anode of the wireless communications system 100, which may be referred to as a network node, or a wireless node, may be a network entity 105 (e.g., any network entity described herein), a UE 115 (e.g., any UE described herein), a network controller, an apparatus, a device, a computing system, one or more components, or another suitable processing entity configured to perform any of the techniques described herein. For example, a node may be a UE 115. As another example, a node may be a network entity 105. As another example, a first node may be configured to communicate with a second node or a third node. In one aspect of this example, the first node may be a UE 115, the second node may be a network entity 105, and the third node may be a UE 115. In another aspect of this example, the first node may be a UE 115, the second node may be a network entity 105, and the third node may be a network entity 105. In yet other aspects of this example, the first, second, and third nodes may be different relative to these examples. Similarly, reference to a UE 115, network entity 105, apparatus, device, computing system, or the like may include disclosure of the UE 115, network entity 105, apparatus, device, computing system, or the like being a node. For example, disclosure that a UE 115 is configured to receive information from a network entity 105 also discloses that a first node is configured to receive information from a second node.

In some examples, network entities 105 may communicate with the core network 130, or with one another, or both. For example, network entities 105 may communicate with the core network 130 via one or more backhaul communication links 120 (e.g., in accordance with an S1, N2, N3, or other interface protocol). In some examples, network entities 105 may communicate with one another via a backhaul communication link 120 (e.g., in accordance with an X2, Xn, or other interface protocol) either directly (e.g., directly between network entities 105) or indirectly (e.g., via a core network 130). In some examples, network entities 105 may communicate with one another via a midhaul communication link 162 (e.g., in accordance with a midhaul interface protocol) or a fronthaul communication link 168 (e.g., in accordance with a fronthaul interface protocol), or any combination thereof. The backhaul communication links 120, midhaul communication links 162, or fronthaul communication links 168 may be or include one or more wired links (e.g., an electrical link, an optical fiber link), one or more wireless links (e.g., a radio link, a wireless optical link), among other examples or various combinations thereof. A UE 115 may communicate with the core network 130 via a communication link 155.

One or more of the network entities 105 described herein may include or may be referred to as a base station 140 (e.g., a base transceiver station, a radio base station, an NR base station, an access point, a radio transceiver, a NodeB, an eNodeB (eNB), a next-generation NodeB or a giga-NodeB (either of which may be referred to as a gNB), a 5G NB, a next-generation eNB (ng-eNB), a Home NodeB, a Home eNodeB, or other suitable terminology). In some examples, a network entity 105 (e.g., a base station 140) may be implemented in an aggregated (e.g., monolithic, standalone) base station architecture, which may be configured to utilize a protocol stack that is physically or logically integrated within a single network entity 105 (e.g., a single RAN node, such as a base station 140).

In some examples, a network entity 105 may be implemented in a disaggregated architecture (e.g., a disaggregated base station architecture, a disaggregated RAN architecture), which may be configured to utilize a protocol stack that is physically or logically distributed among two or more network entities 105, such as an integrated access backhaul (IAB) network, an open RAN (O-RAN) (e.g., a network configuration sponsored by the O-RAN Alliance), or a virtualized RAN (vRAN) (e.g., a cloud RAN (C-RAN)). For example, a network entity 105 may include one or more of a central unit (CU) 160, a distributed unit (DU) 165, a radio unit (RU) 170, a RAN Intelligent Controller (RIC) 175 (e.g., a Near-Real Time RIC (Near-RT RIC), a Non-Real Time RIC (Non-RT RIC)), a Service Management and Orchestration (SMO) 180 system, or any combination thereof. An RU 170 may also be referred to as a radio head, a smart radio head, a remote radio head (RRH), a remote radio unit (RRU), or a transmission reception point (TRP). One or more components of the network entities 105 in a disaggregated RAN architecture may be co-located, or one or more components of the network entities 105 may be located in distributed locations (e.g., separate physical locations). In some examples, one or more network entities 105 of a disaggregated RAN architecture may be implemented as virtual units (e.g., a virtual CU (VCU), a virtual DU (VDU), a virtual RU (VRU)).

The split of functionality between a CU 160, a DU 165, and an RU 170 is flexible and may support different functionalities depending on which functions (e.g., network layer functions, protocol layer functions, baseband functions, RF functions, and any combinations thereof) are performed at a CU 160, a DU 165, or an RU 170. For example, a functional split of a protocol stack may be employed between a CU 160 and a DU 165 such that the CU 160 may support one or more layers of the protocol stack and the DU 165 may support one or more different layers of the protocol stack. In some examples, the CU 160 may host upper protocol layer (e.g., layer 3 (L3), layer 2 (L2)) functionality and signaling (e.g., Radio Resource Control (RRC), service data adaption protocol (SDAP), Packet Data Convergence Protocol (PDCP)). The CU 160 may be connected to one or more DUs 165 or RUs 170, and the one or more DUs 165 or RUs 170 may host lower protocol layers, such as layer 1 (L1) (e.g., physical (PHY) layer) or L2 (e.g., radio link control (RLC) layer, medium access control (MAC) layer) functionality and signaling, and may each be at least partially controlled by the CU 160. Additionally, or alternatively, a functional split of the protocol stack may be employed between a DU 165 and an RU 170 such that the DU 165 may support one or more layers of the protocol stack and the RU 170 may support one or more different layers of the protocol stack. The DU 165 may support one or multiple different cells (e.g., via one or more RUs 170). In some cases, a functional split between a CU 160 and a DU 165, or between a DU 165 and an RU 170 may be within a protocol layer (e.g., some functions for a protocol layer may be performed by one of a CU 160, a DU 165, or an RU 170, while other functions of the protocol layer are performed by a different one of the CU 160, the DU 165, or the RU 170). A CU 160 may be functionally split further into CU control plane (CU-CP) and CU user plane (CU-UP) functions. A CU 160 may be connected to one or more DUs 165 via a midhaul communication link 162 (e.g., F1, F1-c, F1-u), and a DU 165 may be connected to one or more RUs 170 via a fronthaul communication link 168 (e.g., open fronthaul (FH) interface). In some examples, a midhaul communication link 162 or a fronthaul communication link 168 may be implemented in accordance with an interface (e.g., a channel) between layers of a protocol stack supported by respective network entities 105 that are in communication via such communication links.

In wireless communications systems (e.g., wireless communications system 100), infrastructure and spectral resources for radio access may support wireless backhaul link capabilities to supplement wired backhaul connections, providing an IAB network architecture (e.g., to a core network 130). In some cases, in an IAB network, one or more network entities 105 (e.g., IAB nodes 104) may be partially controlled by each other. One or more IAB nodes 104 may be referred to as a donor entity or an IAB donor. One or more DUs 165 or one or more RUs 170 may be partially controlled by one or more CUs 160 associated with a donor network entity 105 (e.g., a donor base station 140). The one or more donor network entities 105 (e.g., IAB donors) may be in communication with one or more additional network entities 105 (e.g., IAB nodes 104) via supported access and backhaul links (e.g., backhaul communication links 120). IAB nodes 104 may include an IAB mobile termination (IAB-MT) controlled (e.g., scheduled) by DUs 165 of a coupled IAB donor. An IAB-MT may include an independent set of antennas for relay of communications with UEs 115, or may share the same antennas (e.g., of an RU 170) of an IAB node 104 used for access via the DU 165 of the IAB node 104 (e.g., referred to as virtual IAB-MT (vIAB-MT)). In some examples, the IAB nodes 104 may include DUs 165 that support communication links with additional entities (e.g., IAB nodes 104, UEs 115) within the relay chain or configuration of the access network (e.g., downstream). In such cases, one or more components of the disaggregated RAN architecture (e.g., one or more IAB nodes 104 or components of IAB nodes 104) may be configured to operate according to the techniques described herein.

In the case of the techniques described herein applied in the context of a disaggregated RAN architecture, one or more components of the disaggregated RAN architecture may be configured to support adaptive CSI reporting for predictive beam management as described herein. For example, some operations described as being performed by a UE 115 or a network entity 105 (e.g., a base station 140) may additionally, or alternatively, be performed by one or more components of the disaggregated RAN architecture (e.g., IAB nodes 104, DUs 165, CUs 160, RUs 170, RIC 175, SMO 180).

A UE 115 may include or may be referred to as a mobile device, a wireless device, a remote device, a handheld device, or a subscriber device, or some other suitable terminology, where the “device” may also be referred to as a unit, a station, a terminal, or a client, among other examples. A UE 115 may also include or may be referred to as a personal electronic device such as a cellular phone, a personal digital assistant (PDA), a tablet computer, a laptop computer, or a personal computer. In some examples, a UE 115 may include or be referred to as a wireless local loop (WLL) station, an Internet of Things (IoT) device, an Internet of Everything (IoE) device, or a machine type communications (MTC) device, among other examples, which may be implemented in various objects such as appliances, or vehicles, meters, among other examples.

The UEs 115 described herein may be able to communicate with various types of devices, such as other UEs 115 that may sometimes act as relays as well as the network entities 105 and the network equipment including macro eNBs or gNBs, small cell eNBs or gNBs, or relay base stations, among other examples, as shown in FIG. 1.

The UEs 115 and the network entities 105 may wirelessly communicate with one another via one or more communication links 125 (e.g., an access link) using resources associated with one or more carriers. The term “carrier” may refer to a set of RF spectrum resources having a defined physical layer structure for supporting the communication links 125. For example, a carrier used for a communication link 125 may include a portion of a RF spectrum band (e.g., a bandwidth part (BWP)) that is operated according to one or more physical layer channels for a given radio access technology (e.g., LTE, LTE-A, LTE-A Pro, NR). Each physical layer channel may carry acquisition signaling (e.g., synchronization signals, system information), control signaling that coordinates operation for the carrier, user data, or other signaling. The wireless communications system 100 may support communication with a UE 115 using carrier aggregation or multi-carrier operation. A UE 115 may be configured with multiple downlink component carriers and one or more uplink component carriers according to a carrier aggregation configuration. Carrier aggregation may be used with both frequency division duplexing (FDD) and time division duplexing (TDD) component carriers. Communication between a network entity 105 and other devices may refer to communication between the devices and any portion (e.g., entity, sub-entity) of a network entity 105. For example, the terms “transmitting,” “receiving,” or “communicating,” when referring to a network entity 105, may refer to any portion of a network entity 105 (e.g., a base station 140, a CU 160, a DU 165, a RU 170) of a RAN communicating with another device (e.g., directly or via one or more other network entities 105).

Signal waveforms transmitted via a carrier may be made up of multiple subcarriers (e.g., using multi-carrier modulation (MCM) techniques such as orthogonal frequency division multiplexing (OFDM) or discrete Fourier transform spread OFDM (DFT-S-OFDM)). In a system employing MCM techniques, a resource element may refer to resources of one symbol period (e.g., a duration of one modulation symbol) and one subcarrier, in which case the symbol period and subcarrier spacing may be inversely related. The quantity of bits carried by each resource element may depend on the modulation scheme (e.g., the order of the modulation scheme, the coding rate of the modulation scheme, or both), such that a relatively higher quantity of resource elements (e.g., in a transmission duration) and a relatively higher order of a modulation scheme may correspond to a relatively higher rate of communication. A wireless communications resource may refer to a combination of an RF spectrum resource, a time resource, and a spatial resource (e.g., a spatial layer, a beam), and the use of multiple spatial resources may increase the data rate or data integrity for communications with a UE 115.

The time intervals for the network entities 105 or the UEs 115 may be expressed in multiples of a basic time unit which may, for example, refer to a sampling period of Tₛ=1/(Δfₘₐₓ·N_{f}) seconds, for which Δfₘₐₓ may represent a supported subcarrier spacing, and N_{f} may represent a supported discrete Fourier transform (DFT) size. Time intervals of a communications resource may be organized according to radio frames each having a specified duration (e.g., 10 milliseconds (ms)). Each radio frame may be identified by a system frame number (SFN) (e.g., ranging from 0 to 1023).

Each frame may include multiple consecutively-numbered subframes or slots, and each subframe or slot may have the same duration. In some examples, a frame may be divided (e.g., in the time domain) into subframes, and each subframe may be further divided into a quantity of slots. Alternatively, each frame may include a variable quantity of slots, and the quantity of slots may depend on subcarrier spacing. Each slot may include a quantity of symbol periods (e.g., depending on the length of the cyclic prefix prepended to each symbol period). In some wireless communications systems 100, a slot may further be divided into multiple mini-slots associated with one or more symbols. Excluding the cyclic prefix, each symbol period may be associated with one or more (e.g., N_{f}) sampling periods. The duration of a symbol period may depend on the subcarrier spacing or frequency band of operation.

A subframe, a slot, a mini-slot, or a symbol may be the smallest scheduling unit (e.g., in the time domain) of the wireless communications system 100 and may be referred to as a transmission time interval (TTI). In some examples, the TTI duration (e.g., a quantity of symbol periods in a TTI) may be variable. Additionally, or alternatively, the smallest scheduling unit of the wireless communications system 100 may be dynamically selected (e.g., in bursts of shortened TTIs (sTTIs)).

Physical channels may be multiplexed for communication using a carrier according to various techniques. A physical control channel and a physical data channel may be multiplexed for signaling via a downlink carrier, for example, using one or more of time division multiplexing (TDM) techniques, frequency division multiplexing (FDM) techniques, or hybrid TDM-FDM techniques. A control region (e.g., a control resource set (CORESET)) for a physical control channel may be defined by a set of symbol periods and may extend across the system bandwidth or a subset of the system bandwidth of the carrier. One or more control regions (e.g., CORESETs) may be configured for a set of the UEs 115. For example, one or more of the UEs 115 may monitor or search control regions for control information according to one or more search space sets, and each search space set may include one or multiple control channel candidates in one or more aggregation levels arranged in a cascaded manner. An aggregation level for a control channel candidate may refer to an amount of control channel resources (e.g., control channel elements (CCEs)) associated with encoded information for a control information format having a given payload size. Search space sets may include common search space sets configured for sending control information to multiple UEs 115 and UE-specific search space sets for sending control information to a specific UE 115.

In some examples, a network entity 105 (e.g., a base station 140, an RU 170) may be movable and therefore provide communication coverage for a moving coverage area 110. In some examples, different coverage areas 110 associated with different technologies may overlap, but the different coverage areas 110 may be supported by the same network entity 105. In some other examples, the overlapping coverage areas 110 associated with different technologies may be supported by different network entities 105. The wireless communications system 100 may include, for example, a heterogeneous network in which different types of the network entities 105 provide coverage for various coverage areas 110 using the same or different radio access technologies.

The wireless communications system 100 may be configured to support ultra-reliable communications or low-latency communications, or various combinations thereof. For example, the wireless communications system 100 may be configured to support ultra-reliable low-latency communications (URLLC). The UEs 115 may be designed to support ultra-reliable, low-latency, or critical functions. Ultra-reliable communications may include private communication or group communication and may be supported by one or more services such as push-to-talk, video, or data. Support for ultra-reliable, low-latency functions may include prioritization of services, and such services may be used for public safety or general commercial applications. The terms ultra-reliable, low-latency, and ultra-reliable low-latency may be used interchangeably herein.

In some examples, a UE 115 may be configured to support communicating directly with other UEs 115 via a device-to-device (D2D) communication link 135 (e.g., in accordance with a peer-to-peer (P2P), D2D, or sidelink protocol). In some examples, one or more UEs 115 of a group that are performing D2D communications may be within the coverage area 110 of a network entity 105 (e.g., a base station 140, an RU 170), which may support aspects of such D2D communications being configured by (e.g., scheduled by) the network entity 105. In some examples, one or more UEs 115 of such a group may be outside the coverage area 110 of a network entity 105 or may be otherwise unable to or not configured to receive transmissions from a network entity 105. In some examples, groups of the UEs 115 communicating via D2D communications may support a one-to-many (1:M) system in which each UE 115 transmits to each of the other UEs 115 in the group. In some examples, a network entity 105 may facilitate the scheduling of resources for D2D communications. In some other examples, D2D communications may be carried out between the UEs 115 without an involvement of a network entity 105.

The core network 130 may provide user authentication, access authorization, tracking, Internet Protocol (IP) connectivity, and other access, routing, or mobility functions. The core network 130 may be an evolved packet core (EPC) or 5G core (5GC), which may include at least one control plane entity that manages access and mobility (e.g., a mobility management entity (MME), an access and mobility management function (AMF)) and at least one user plane entity that routes packets or interconnects to external networks (e.g., a serving gateway (S-GW), a Packet Data Network (PDN) gateway (P-GW), or a user plane function (UPF)). The control plane entity may manage non-access stratum (NAS) functions such as mobility, authentication, and bearer management for the UEs 115 served by the network entities 105 (e.g., base stations 140) associated with the core network 130. User IP packets may be transferred through the user plane entity, which may provide IP address allocation as well as other functions. The user plane entity may be connected to IP services 150 for one or more network operators. The IP services 150 may include access to the Internet, Intranet(s), an IP Multimedia Subsystem (IMS), or a Packet-Switched Streaming Service.

The wireless communications system 100 may operate using one or more frequency bands, which may be in the range of 300 megahertz (MHz) to 300 gigahertz (GHz). Generally, the region from 300 MHz to 3 GHz is known as the ultra-high frequency (UHF) region or decimeter band because the wavelengths range from approximately one decimeter to one meter in length. UHF waves may be blocked or redirected by buildings and environmental features, which may be referred to as clusters, but the waves may penetrate structures sufficiently for a macro cell to provide service to the UEs 115 located indoors. Communications using UHF waves may be associated with smaller antennas and shorter ranges (e.g., less than 100 kilometers) compared to communications using the smaller frequencies and longer waves of the high frequency (HF) or very high frequency (VHF) portion of the spectrum below 300 MHz.

The wireless communications system 100 may utilize both licensed and unlicensed RF spectrum bands. For example, the wireless communications system 100 may employ License Assisted Access (LAA), LTE-Unlicensed (LTE-U) radio access technology, or NR technology using an unlicensed band such as the 5 GHz industrial, scientific, and medical (ISM) band. While operating using unlicensed RF spectrum bands, devices such as the network entities 105 and the UEs 115 may employ carrier sensing for collision detection and avoidance. In some examples, operations using unlicensed bands may be based on a carrier aggregation configuration in conjunction with component carriers operating using a licensed band (e.g., LAA). Operations using unlicensed spectrum may include downlink transmissions, uplink transmissions, P2P transmissions, or D2D transmissions, among other examples.

A network entity 105 (e.g., a base station 140, an RU 170) or a UE 115 may be equipped with multiple antennas, which may be used to employ techniques such as transmit diversity, receive diversity, multiple-input multiple-output (MIMO) communications, or beamforming. The antennas of a network entity 105 or a UE 115 may be located within one or more antenna arrays or antenna panels, which may support MIMO operations or transmit or receive beamforming. For example, one or more base station antennas or antenna arrays may be co-located at an antenna assembly, such as an antenna tower. In some examples, antennas or antenna arrays associated with a network entity 105 may be located at diverse geographic locations. A network entity 105 may include an antenna array with a set of rows and columns of antenna ports that the network entity 105 may use to support beamforming of communications with a UE 115. Likewise, a UE 115 may include one or more antenna arrays that may support various MIMO or beamforming operations. Additionally, or alternatively, an antenna panel may support RF beamforming for a signal transmitted via an antenna port.

Beamforming, which may also be referred to as spatial filtering, directional transmission, or directional reception, is a signal processing technique that may be used at a transmitting device or a receiving device (e.g., a network entity 105, a UE 115) to shape or steer an antenna beam (e.g., a transmit beam, a receive beam) along a spatial path between the transmitting device and the receiving device. Beamforming may be achieved by combining the signals communicated via antenna elements of an antenna array such that some signals propagating along particular orientations with respect to an antenna array experience constructive interference while others experience destructive interference. The adjustment of signals communicated via the antenna elements may include a transmitting device or a receiving device applying amplitude offsets, phase offsets, or both to signals carried via the antenna elements associated with the device. The adjustments associated with each of the antenna elements may be defined by a beamforming weight set associated with a particular orientation (e.g., with respect to the antenna array of the transmitting device or receiving device, or with respect to some other orientation).

A network entity 105 or a UE 115 may use beam sweeping techniques as part of beamforming operations. For example, a network entity 105 (e.g., a base station 140, an RU 170) may use multiple antennas or antenna arrays (e.g., antenna panels) to conduct beamforming operations for directional communications with a UE 115. Some signals (e.g., synchronization signals, reference signals, beam selection signals, or other control signals) may be transmitted by a network entity 105 multiple times along different directions. For example, the network entity 105 may transmit a signal according to different beamforming weight sets associated with different directions of transmission. Transmissions along different beam directions may be used to identify (e.g., by a transmitting device, such as a network entity 105, or by a receiving device, such as a UE 115) a beam direction for later transmission or reception by the network entity 105.

Some signals, such as data signals associated with a particular receiving device, may be transmitted by transmitting device (e.g., a transmitting network entity 105, a transmitting UE 115) along a single beam direction (e.g., a direction associated with the receiving device, such as a receiving network entity 105 or a receiving UE 115). In some examples, the beam direction associated with transmissions along a single beam direction may be determined based on a signal that was transmitted along one or more beam directions. For example, a UE 115 may receive one or more of the signals transmitted by the network entity 105 along different directions and may report to the network entity 105 an indication of the signal that the UE 115 received with a highest signal quality or an otherwise acceptable signal quality.

In some examples, transmissions by a device (e.g., by a network entity 105 or a UE 115) may be performed using multiple beam directions, and the device may use a combination of digital precoding or beamforming to generate a combined beam for transmission (e.g., from a network entity 105 to a UE 115). The UE 115 may report feedback that indicates precoding weights for one or more beam directions, and the feedback may correspond to a configured set of beams across a system bandwidth or one or more sub-bands. The network entity 105 may transmit a reference signal (e.g., a cell-specific reference signal (CRS), a CSI reference signal (CSI-RS)), which may be precoded or unprecoded. The UE 115 may provide feedback for beam selection, which may be a precoding matrix indicator (PMI) or codebook-based feedback (e.g., a multi-panel type codebook, a linear combination type codebook, a port selection type codebook). Although these techniques are described with reference to signals transmitted along one or more directions by a network entity 105 (e.g., a base station 140, an RU 170), a UE 115 may employ similar techniques for transmitting signals multiple times along different directions (e.g., for identifying a beam direction for subsequent transmission or reception by the UE 115) or for transmitting a signal along a single direction (e.g., for transmitting data to a receiving device).

A receiving device (e.g., a UE 115) may perform reception operations in accordance with multiple receive configurations (e.g., directional listening) when receiving various signals from a receiving device (e.g., a network entity 105), such as synchronization signals, reference signals, beam selection signals, or other control signals. For example, a receiving device may perform reception in accordance with multiple receive directions by receiving via different antenna subarrays, by processing received signals according to different antenna subarrays, by receiving according to different receive beamforming weight sets (e.g., different directional listening weight sets) applied to signals received at multiple antenna elements of an antenna array, or by processing received signals according to different receive beamforming weight sets applied to signals received at multiple antenna elements of an antenna array, any of which may be referred to as “listening” according to different receive configurations or receive directions. In some examples, a receiving device may use a single receive configuration to receive along a single beam direction (e.g., when receiving a data signal). The single receive configuration may be aligned along a beam direction determined based on listening according to different receive configuration directions (e.g., a beam direction determined to have a highest signal strength, highest signal-to-noise ratio (SNR), or otherwise acceptable signal quality based on listening according to multiple beam directions).

The wireless communications system 100 may be a packet-based network that operates according to a layered protocol stack. In the user plane, communications at the bearer or PDCP layer may be IP-based. An RLC layer may perform packet segmentation and reassembly to communicate via logical channels. A MAC layer may perform priority handling and multiplexing of logical channels into transport channels. The MAC layer also may implement error detection techniques, error correction techniques, or both to support retransmissions to improve link efficiency. In the control plane, an RRC layer may provide establishment, configuration, and maintenance of an RRC connection between a UE 115 and a network entity 105 or a core network 130 supporting radio bearers for user plane data. A PHY layer may map transport channels to physical channels.

In some examples, the UE 115 may support a framework for beam reporting in which the UE 115 may transmit multiple CSI reports to the network entity 105. For example, the UE 115 may transmit in which a first CSI report that indicates a quantity of beam indices (and corresponding confidence values) to be reported in a second CSI report. In some examples, however, using multiple CSI reports to indicate a variable quantity of beam indices (and corresponding confidence values) may lead to increased signaling overhead associated with CSI reporting.

In some other examples, the UE 115 may support a framework for reporting a variable quantity of beams using a single CSI report. For example, the UE 115 may receive control information from the network entity 105 that may indicate a confidence threshold for beam reporting. The UE 115 may also receive a set of reference from the network entity 105. For example, the network entity 105 may use a set of downlink beams to transmit the set of reference signals to the UE 115. Accordingly, the set of reference signals may be associated with the set of downlink beams. The UE 115 may transmit a CSI report to the network entity 105. The CSI report may indicate a subset of beam indices corresponding to a subset of the set of downlink beams. The CSI report may also indicate a corresponding confidence value for each beam index of the subset of beam indices. The subset of confidence values may be indicative of a level of confidence in a predicted viability of the subset of the set of beams. The predicted viability may be based on one or more measurements of the set of reference signals and a quantity of beam indices included in the subset of beam indices may be based on the subset of confidence values collectively satisfying the confidence threshold. In some examples, configuring the UE 115 with the confidence level threshold for beam reporting may lead to improved beam management and increased reliability of communications within the wireless communications system 100, among other benefits.

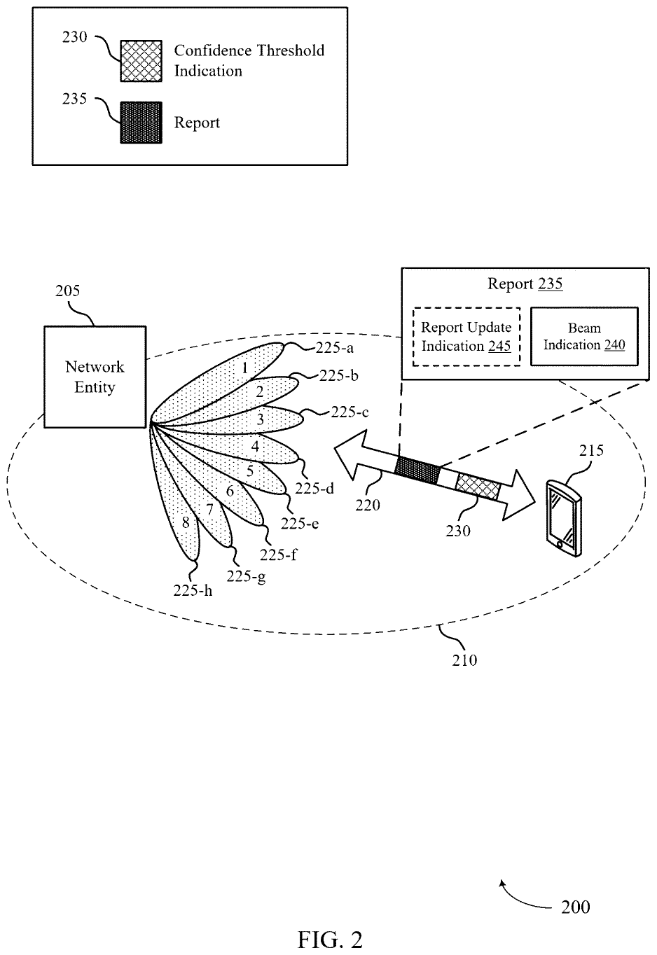

FIG. 2 shows an example of a wireless communications system 200 that supports adaptive CSI reporting for predictive beam management in accordance with one or more aspects of the present disclosure. In some examples, the wireless communications system 200 may implement or be implemented at one or more aspects of the wireless communications system 100. For example, the wireless communications system 200 may include a UE 215, which may be an example of a UE 115 (or another network node) illustrated by and described with reference to FIG. 1. The wireless communications system 200 may also include a network entity 205, which may be an example of one or more of the network entities 105 (e.g., a CU, a DU, an RU, a base station, an IAB node, or one or more other network nodes) illustrated by and described with reference to FIG. 1. The UE 215 and the network entity 205 may communicate with a coverage area 210, which may be an example of a coverage area 110 illustrated by and described with reference to FIG. 1. For example, the UE 215 and the network entity 205 may communicate within the coverage area 210 via a communication link 220, which may be an example of a communication link 125 (e.g., a Uu link) illustrated by and described with reference to FIG. 1. In the example of FIG. 2, the network entity 205 may use one or more beams (e.g., a beam 225-a, a beam 225-b, a beam 225-c, a beam 225-d, a beam 225-e, a beam 225-f, a beam 225-g, and a beam 225-h) to communicate with the UE 215.

The network entity 205 and the UE 215 may use one or more beam management techniques to improve a capacity of wireless communications between the network entity 205 and the UE 215 (e.g., via the communication link 220). In some examples, the UE 215 and the network entity 205 may use one or more beam management techniques to improve initial access procedures, tracking procedures, and to identify a beam pair for wireless communications between the UE 215 and the network entity 205 (e.g., a gNB). For example, the UE 215 may operate in one or more radio resource control (RRC) states, such as an idle state (e.g., indicated via an RRC IDLE information element (IE)), an inactive state (e.g., indicated via an RRC inactive IE), or a connected state (e.g., indicated via an RRC connected IE). In some examples, the network entity 205 and the UE 215 may perform an initial access procedure subsequent to the UE 215 operating in the idle state or inactive state. For example, the network entity 205 may perform a beam sweeping procedure in which the network entity 205 may use one or more of the beams 225 (e.g., relatively wide beams, such as synchronization signal block (SSB) beams) to transmit reference signals (e.g., SSBs) to the UE 215. The UE 215 may use information communicated via one or more of the SSBs to perform an initial access procedure, such as a contention free random access (CFRA) procedure or a contention based random access (CBRA) procedure. During the initial access procedure, the UE 215 may use one or more random access occasions to transmit a random access preamble to the network entity 205, for example, to establish a connection with the network entity 205.

In some examples, while the UE 215 may be operating in the idle state or inactive state, the UE 215 may use tracking reference signals (TRSs), in which configurations for the TRS may be provided to the UE 215 in system information, such as for paging reception at the UE 215 (e.g., to conserver power). In a cell in which TRS may be available for the UE 215 to use while the UE 215 may be operating in the idle state or the inactive state, an availability of configured TRS may be informed to the UE 215 via signaling, such as L1 signaling (e.g., from the network entity 205).

In some examples, such as examples in which the UE 215 may be operating in the connected state, the UE 215 may receive downlink communications from the network entity 205 via a directional beam (e.g., one of the beams 225), such as may be used to transmit one or more reference signals. In some instances, an established connection (e.g., the communication link 220, which may also be referred to as a radio link or a link) may be susceptible to blockages and degradation, which may cause interruptions in the radio link or a radio link failure. That is, the downlink communications from the network entity 205 may be dropped. To reduce the likelihood of radio link failures occurring or to recover after a radio link failure, the UE 215 may perform one or more beam management procedures, such as a beam failure prevention procedure or a beam failure recovery procedure.

For example, the UE 215 may perform the beam failure recovery procedure to reestablish a connection with the network entity 205 and select another (e.g., different) beam pair for communications with the network entity 205. The beam pair may include a beam of the network entity 205 (e.g., a beam associated with a cell supported by the network entity 205, one of the beams 225) and a beam of the UE 215. In some examples, the beam management procedures may include one or more processes for downlink beam management, such as beam selection (P1), transmit beam refinement for the network entity 205 (P2), and receive beam refinement for the UE 215 (P3). In some examples, P1, P2, and P3 may include transmission of one or more reference signals from the network entity 205, such as SSBs or CSI-RS. Additionally, the beam management procedures may include one or more other processes for uplink beam management (e.g., U1, U2, U3), which may include transmission of uplink reference signals (e.g., sounding reference signals (SRS)) from the UE 215. In some examples, beam management procedures at the UE 215 or the network entity 205 (or both) may include L1-based (or L2-based) measurement reporting (e.g., L1-RSRP reporting, L1-SINR reporting), transmission configuration indicator (TCI) state configurations (e.g., indications from the network entity 205), component carrier group (CC-group) beam updates, relatively fast uplink beam updates, unified TCI state reporting, L1-centric or L2-centric mobility reporting, dynamic TCI updates, uplink multi-panel selection, and maximum permitted exposure (MPE) mitigation, among other possible examples that may lead to beam management latency reduction. The UE 215 and the network entity 205 may support one or more beam management techniques for high-speed train (HST), single frequency network (SFN), and multiple TRP (mTRP) deployments, among other examples.

In some examples, the UE 215 may detect interruptions in the radio link or detects a radio link failure based on measurements, such as measurements on beam failure detection reference signals (BFD-RSs) or physical downlink control channel (PDCCH) block error rate (BLER) measurements. In such examples, the UE 215 may perform a recovery procedure (e.g., beam failure recovery procedure) to reduce a link interruption time or a link failure time. The recover procedure may be for a primary cell (PCell), primary cell of a secondary cell group (PSCell), or a secondary cell (SCell). In some examples, the recover procedure may be based on a random access procedure (e.g., CFRA). Additionally, in some examples, the recover procedure may include transmission of a link recovery request (e.g., via a scheduling request). In some examples, the recovery procedure may be a MAC control element (MAC-CE) based beam failure recover procedure (e.g., for an SCell).

In some examples, the UE 215 or the network entity 205, or both, may support AI/ML-based beam management. For example, the UE 215 and the network entity 205 may support one or more techniques for predictive beam management using AI/ML. In some examples, the UE 215 (or the network entity 205) may support one or more AI/ML-based beam management techniques for characterization and performance (e.g., baseline performance) evaluations. For example, the UE 215 may support AI/ML-based beam management for performance monitoring. An AI/ML-based beam management technique may include spatial-domain downlink beam predictions. For example, the UE 215 may use AI/ML to predict measurements for a first set of downlink beams (e.g., a prediction target, which may be referred to as set A) based on measurement results (e.g., actual measurements) of reference signals transmitted to the UE 215 using a second set of downlink beams (e.g., a measurement source, which may be referred to as set B). For example, the UE 215 may use AI/ML to predict measurements for a first set of the beams 225 (e.g., set A) based on measurement results (e.g., actual measurements) of reference signals transmitted to the UE 215 using a second set of the beams 225 (e.g., set B). Predicted measurements and actual measurements may include RSRP measurements or SINR measurements, among other possible examples of received power measurements. In other words, predicted measurement results and actual measurement results may include received power metrics, such as RSRSP values or SINR values. In some examples, one or more of the beams 225 may be common to set A and set B. For example, the network entity 205 may use one or more of the beams 225 to transmit the set of reference signals to the UE 215 and the UE 215 may predict measurements for a same one or more of the beams 225 or a different one or more of the beams 225 (e.g., based on measurements of the transmitted set of reference signals).

In some examples, in the spatial-domain, set A may correspond to a first set of reference signal resources (e.g., SSB resources or CSI-RS resources) and set B may correspond to a second set of reference signal resources (e.g., CSI-RS resources or SSB resources). That is, for spatial-domain downlink beam predictions, the UE 215 may predict measurements for the first set of reference signal resources (e.g., based on actual measurements of the second set of reference signal resources). A reference signal resource (e.g., each reference signal resource) included in the first set of reference signal resources may correspond to a respective beam included in the first set of beams (e.g., set A). Additionally, the predicted measurements may be based on actual measurements of a set of reference signals transmitted using the second set of reference signal resources. A reference signal resource (e.g., each reference signal resource) included in the second set of reference signal resources may correspond to a respective beam (e.g., used to transmit the corresponding reference signal) included in the second set of beams (e.g., set B). In some other examples, set A may include a subset (e.g., a down-sampled version) of set B. That is, the first set of reference signal resources (e.g., the first set of the beams 225) may include a subset of the second set of reference signal resources (e.g., the second set of the beams 225).

Another AI/ML-based beam management technique may include time-domain downlink beam predictions. For example, the UE 215 may use AI/ML to predict measurements (e.g., RSRP measurements, SINR measurements) for a first set of beams (e.g., set A) based on previous (e.g., historic) measurement results of a second set of beams (e.g., set B). In some examples, set A may correspond to a set of reference signal resources at a first time occasion and set B may correspond to the same set of reference signal resources at a second time occasion (e.g., a previous time occasion). In some other examples, set A may correspond to a first set of reference signal resources and set B may correspond to a second set of reference signal resources that may be different from the first set of refence signals. For example, the second set of reference signals may correspond to SSB resources (e.g., the UE 215 may perform measurements of SSBs transmitted using relatively wide beams) and the first set of reference signals may correspond to CSI-RS resources (e.g., the UE 215 may predict measurements for CSI-RS that may be transmitted using relatively narrow beams). In some examples, beams in set A and set B may be in a same frequency range. That is, the first set of reference signal resources and the second set of reference signal resources may include frequencies within a same frequency range.

In some examples, the UE 215 may be configured to determine a respective quantity of beams (e.g., reference signal resources) to be included in set A and set B. Additionally, the UE 215 may select set A out of the beams (e.g., reference signal resources) in set B (e.g., according to a fixed pattern, a random pattern). For example, the UE 215 may select set A from set B based on the determined quantity of beams to be included in set A. That is, set A may be a subset of set B. In some examples, the UE 215, may be configured to determine whether set A and set B are to be different (e.g., whether set A may include relatively narrow beams and set B may include relatively wide beams). Accordingly, the UE 215 may determine a quasi co-location (QCL) relationship between beams in set A and beams in set B. In some examples, set A may be for downlink beam predictions and set B may be for downlink beam measurements. Additionally, in some examples, the UE 215 may be configured with one or more codebook constructions of set A and set B.

In some examples, such as for spatial-domain beam predictions, the wireless communications system 200 may support use of a UE-side AI/ML model for beam management that may include L1 signaling from the UE 215 to report information associated with an AI/ML model inference (e.g., prediction) to the network entity 205. In such examples, one or more beams used for downlink communications with the UE 215 may be based on the AI/ML model inference. That is, one or more beams used for downlink communications with the UE 215 may be based on an output of AI/ML model inference at the UE 215. In some examples, the UE 215 may report predicted L1-RSRP measurements (or L1-SINR measurements) corresponding to one or more beams (e.g., one or more reference signal resources).

In some other examples, such as for time-domain predictions, the wireless communications system 200 may support use of a UE-side AI/ML model for beam management that may include L1 signaling from the UE 215 to report information associated with an AI/ML model inference to the network entity 205. In such examples, one or more beams (e.g., reference signal resources) at a quantity (N) of future time instances (e.g., time occasions) may be based on the AI/ML model inference. That is, one or more beams used for downlink communications with the UE 215 at a quantity of future time occasions may be based on an output of the AI/ML model inference at the UE 215. In some examples, the UE 215 may be configured with a value of N. Additionally, for time-domain predictions, the wireless communications system 200 may support use of a UE-side AI/ML model for beam management that may include L1 signaling from the UE 215 to report information associated with an AI/ML model inference to the network entity 205. In some examples, one or more beams (e.g., reference signal resources) at a quantity (N) of future time instances (e.g., time occasions) may be based on an output of the AI/ML model inference (e.g., at the UE 215). In some examples, the UE 215 may be configured with a value of N. In some examples, the UE 215 may report may predicted L1-RSRP measurements corresponding to one or more beams (e.g., one or more reference signal resources). In such examples, the UE 215 may also report information regarding a timestamp corresponding to the reported one or more beams (e.g., the reported one or more reference signal resources). The timestamp information may be explicitly or implicitly indicated via a report (e.g., a report used to report information associated with the one or more beams).

In some examples, such as for spatial-domain predictions and for time-domain predictions with a UE-side AI/ML model, the wireless communications system 200 may support model monitoring with potential down-selection. For example, the wireless communications system 200 may support UE-side model monitoring in which the UE 215 may monitor performance metrics associated with the AI/ML model or with wireless communications between the UE 215 and the network entity 205 (or both). In some examples, the UE 215 may make one or more determinations regarding model selection, activation, deactivation, switching, and fallback operations, among other examples. Additionally, or alternatively, the wireless communications system 200 may support network-side model monitoring in which the network entity 205 may monitor performance metrics associated with the AI/ML model or with wireless communications between the UE 215 and the network entity 205 (or both). Additionally, in some examples, the network entity 205 may make one or more determinations regarding model selection, activation, deactivation, switching, and fallback operations, among other examples. The wireless communications system 200 may support hybrid model monitoring in which the UE 215 may monitor one or more performance metrics and the network entity 205 may make one or more determination regarding model selection, activation, deactivation, switching, and fallback operations.

In some examples, such as for spatial-domain predictions or time-domain predictions with a UE-side AI/ML model and network-side model monitoring, the network entity 205 may monitor one or more performance metrics and make one or more determinations regarding model selection, activation, deactivation, switching, and fallback operations. Additionally, in some examples of network-side model monitoring for a network-side AI/ML model (e.g., for spatial-domain predictions and for time-domain predictions), the UE 215 may be configured to perform beam measurements and transmit a report for model monitoring. In some examples, such as for spatial-domain predictions or for time-domain predictions with a network-side AI/ML model, the UE 215 may support one or more L1 beam reporting enhancement for AI/ML model inference. For example, the UE 215 may report measurement results of multiple (e.g., more than 4) beams in one reporting instance. That is, the UE 215 may report measurement results of multiple (e.g., more than 4) reference signal resources in one reporting instance.

As illustrated in the example of FIG. 2, the wireless communications system 200 may support one or more AI/ML-based predictive beam management techniques. For example, the UE 215 may use AI/ML to predict one or more of the beams 225 (e.g., which of the beams 225) correspond to a top beam. As described herein, a top beam may refer to a beam with a highest beam quality, a highest signal strength, or an otherwise acceptable signal quality relative to other detectable beams. That is, the UE 215 may use AI/ML to predict which of the beams 225 corresponds to the beam with the highest beam quality, the highest signal strength, or the otherwise acceptable signal quality relative to others of the beams 225 that may be detectable at the UE 215. In other words, the UE 215 may use AI/ML to predict which of the beams 225 may be most viable for downlink communications between the network entity 205 and the UE 215.

In some examples, AI/ML-based predictive beam management techniques may provide one or more improvements for beam management at the UE 215 and the network entity 205. For example, by utilizing AI for predictive beam management, the UE 215 and the network entity 205 may predict (e.g., one or more AI/ML models at the UE 215 may produce) a probability (e.g., confidence, likelihood) that one or more of the beams 225 (e.g., each of the beams 225) may correspond to the top beam. For example, for one or more of the beams 225, the UE 215 may predict a probability that the beam may correspond to the top beam. In other words, by using AI to predict the top beam, the UE 215 may determine (and report) a confidence value associated with the prediction. For example, the UE 215 may use AI/ML to predict a viability of a beam (e.g., each of the beams 225) for downlink communications between the UE 215 and the network entity 205 and a level of confidence in the predicted viability. That is, for one or more of the beams 225, the UE 215 may predict a viability of the beam for downlink communications and obtain a level of confidence in the associated prediction.

As an illustrative example, using AI/ML, the UE 215 may predict that a beam 225-b (e.g., a downlink beam with index #2) may be the top beam with a confidence of 1%, a beam 225-c (e.g., a downlink beam with index #3) may be the top beam with a confidence of 26%, and a beam 225-d (e.g., a downlink beam with index #4) may be the top beam with a confidence of 25%. In other words, a predicted viability for the beam 225-b may be associated with a confidence value of 1%, a predicted viability for the beam 225-c may be associated with a confidence value of 26%, and a predicted viability for the beam 225-d may be associated with a confidence value of 25%. The confidence value indicates a level of confidence in the predicted viability of the beam. In some examples, a confidence value of a predicted viability (e.g., a confidence in a prediction) may provide a metric (e.g., a soft metric) to evaluate a quality of the prediction (e.g., rather than reporting a hard-decision that may be based on a relatively noisy beam prediction). That is, the confidence values obtained (e.g., via AI/ML) for the beam 225-b, the beam 225-c, and the beam 225-d may correspond to an estimated probability (e.g., a soft metric) that the respective beam will correspond to the top beam (e.g., of a hard-decision). As such, by reporting the confidence values for the beam 225-b, the beam 225-c, and the beam 225-d to the network entity 205, the UE 215 may enable the network entity 205 to evaluate the quality of the predictions. In some examples, enabling the network entity to evaluate the quality of the predictions may lead to improved beam management at the network entity 205, among other benefits.

In some examples, however, reporting a confidence value (e.g., an estimated probability) for multiple predictions may lead to increased overhead (e.g., may be associated with a cost of an additional overhead). For example, the UE 215 may report beam indices and associated confidence values for multiple of the beams 225 (e.g., all of the beams 225), such that soft-metrics for multiple of the beams 225 (e.g., all soft information) may be communicated to the network entity 205. In such an example, however, reporting the confidence values for multiple of the beams 225 may lead to increased overhead (e.g., may be associated with relatively high overhead).

To reduce overhead, the UE 215 may report the beam index and associated confidence value for one of the beams 225 (e.g., a single top beam, a top-1 predicted beam). For example, the UE 215 may report the beam 225-c and the associated confidence value of 26%. However, such reporting may result in other top beam predictions (e.g., the top beam prediction for the beam 225-d, which may have an associated confidence value of 25%) being unreported. That is, such reporting may lack some information, which may degrade beam prediction performance (e.g., at the UE 215 or the network entity 205). For example, using an AI/ML model, the UE 215 may predict that the beam 225-c corresponds to the top beam among the beams 225 with a confidence value of 26% and the beam 225-d and the beam 225-e both correspond to the top beam among the beams 225 with a confidence value of 25%. Additionally, the UE 215 may determine that the confidence value of 26% corresponds a highest confidence values among confidence values obtained for the beams 225. That is, using the AI/ML model, the UE 215 may determine that the top-1 predicted beam corresponds to the beam 225-c (e.g., the downlink beam with the index #3), which may have an associated confidence of 26%. The UE 215 may be configured to report a single top beam to the network entity 205 and, as such, may indicate an identifier (ID) or index of the top-1 beam (e.g., an ID of the beam 225-c, the index #3). That is, in some examples, the UE 215 may transmit a report to the network entity 205 that indicates a beam index (or another type of ID) that corresponds to the beam 225-c and the confidence value 26%. In such examples, however, the report (e.g., and the network entity 205) may lack other information output by the AI/ML model. For example, the report (e.g., and network entity 205) may lack information associated with the beam 225-d and the beam 225-e, which may both have an associated confidence of 25% and, as such, a relatively high likelihood of being the top beam. Failing to report information associated with beams that may have a relatively high likelihood of being the top beam may degrade a performance of beam management at the network entity 205.

In some other examples, beam reporting by the UE 215 may vary based on confidence values (e.g., probabilities, chance, certainty) output by a predictive AI/ML model. For example, the UE 215 may report a variable quantity of beams in which the quantity of reported beams may be based on a confidence level threshold (e.g., a confidence threshold). That is, the UE 215 may report a variable quantity of beams (e.g., in each report) to satisfy a target confidence threshold. For example, the UE 215 may be configured to report a quantity of top beams (e.g., a top-3 beams, a top-4 beams, or some other suitable quantity of top beams) that may be associated with (e.g., have) relatively high confidence values (e.g., and satisfy the confidence threshold). In some examples, the confidence threshold may correspond to 75%. Additionally, the UE 215 may determine that the beam 225-c corresponds to the top beam among the beams 225 with a confidence value of 26% and the beam 225-d and the beam 225-e both correspond to the top beam among the beams 225 with a confidence value of 25%. That is, using AI/ML, the UE 215 may determine that the beam 225-c, the beam 225-d, and the beam 225-e correspond to the top-3 beams and have a combined confidence value of 76%. Accordingly, in such examples, the UE 215 may report the beam index and associated confidence value for the beam 225-c, the beam 225-d, and the beam 225-e. In some examples, the network entity 205 may sweep the quantity of top beams, for example, before selecting one of the top beams for scheduling (e.g., scheduling downlink communications with the UE 215). In some examples, the selected top beam may be blocked (or otherwise unavailable). In such examples, the network entity 205 may select another of the top beams (e.g., which may be suitable for a relatively fast beam update).

In other examples, the confidence threshold may correspond to 90%. Additionally, using AI/ML, the UE 215 may determine that the beam 225-b (e.g., the downlink beam with index #2) corresponds to the top beam of the beams 225 with a confidence value of 92% and the remaining 7 beams of the beams 225 (e.g., the beam 225-a, the beam 225-c, the beam 225-d, the beam 225-e, the beam 225-f, the beam 225-g, and the beam 225-h) correspond to the top beam of the beams 225 with a combined confidence value of 8%. That is, the UE 215 may determine that the beam 225-b has a confidence value of 92% with the remaining 7 beams have a combined confidence value of 8%. In such an example, the UE 215 may report the beam index and associated confidence value of a single top beam (e.g., the top-1 beam, the beam 225-b). In some examples, reporting beam indices and corresponding confidence values for a variable quantity of beams based on a confidence threshold (e.g., based on a combined confidence value, a sum of probabilities) may lead to reduced reporting overhead and enable the UE 215 to report information associated with beams that may be relatively likely to be top beams to the network entity 205. That is, in some examples, reporting a variable quantity of beams may reduce reporting overhead, while enabling the UE 215 to communicate a suitable quantity of soft beam prediction information (e.g., with each report) to the network entity 205.

In some examples, however, variable beam reporting based on confidence values output by an AI/ML model may lead to ambiguity in reporting between the network entity 205 and the UE 215. That is, for variable beam reporting, a quantity of beam indices indicated via a report may be variable and based on confidence values output by the AI/ML model. As such, the report may have a variable payload depending on the confidence output by the AI/ML model. The network entity 205 may be unaware of the quantity of beam indices being reported or the payload size of the report, or both, and may therefore be unable to decode the report. That is, confidence values predicted for one or more beams may vary (e.g., change) over time and, accordingly, the quantity of beams that satisfy the confidence threshold may also vary over time. For example, the UE 215 may transmit multiple reports to the network entity 205 over a duration and the quantity of reported beams may varies across the multiple reports. In such an example, the network entity 205 may be unaware of the payload size of a report (e.g., of the multiple reports) and may therefore be unable to decode the report. In some examples, to reduce ambiguity for variable beam reporting (e.g., payload size ambiguity), the UE 215 may use multiple reports (e.g., two CSI reports) to report a variable quantity of beams. In such examples, however, transmitting multiple reports (e.g., two separate CSI reports, two-part CSI reporting) to convey a variable quantity of beams may lead to increased complexity and increased signaling overhead.

In some examples, techniques for adaptive CSI reporting for predictive beam management, as described herein, may provide a framework for reporting a variable quantity of beams using a single report (e.g., a single CSI report). For example, the framework may enable the UE 215 to report variable quantity of predicted beams based on confidence values output by the AI/ML model and may lead to reduced report ambiguity between the gNB and the UE. In some examples, using a single report design may reduce a complexity of the report, a latency associated with CSI reporting, and signaling overhead.

As illustrated in the example of FIG. 2, the UE 215 may be configured to use a single report to report a quantity of top beams whose corresponding confidence values satisfy a confidence threshold. For example, the UE 215 may receive a confidence threshold indication 230 from the network entity 205. The confidence threshold indication 230 (e.g., control information) may indicate a confidence threshold for beam reporting. The UE 215 may also receive a set of reference signals (e.g., one or more SSBs, one or more CSI-RSs, one or more TRSs) from the network entity 205. For example, the network entity 205 may use the beams 225 to transmit the set of reference signals to the UE 215. Accordingly, the set of reference signals may be associated with the beams 225 (e.g., each reference signal may be associated with a respective one of the beams 225).

The UE may transmit the report 235 to the network entity 205. The report 235 may include a beam indication 240, which may indicate a subset of beam indices corresponding to a subset of the beams 225. For example, the subset of the beams 225 may include the beam 225-c, the beam 225-d, and the beam 225-e. Accordingly, the subset of beam indices may include beam index #3, beam index #4, and beam index #5. The report 235 may also indicate a corresponding confidence value for each beam index of the subset of beam indices. For example, the report may indicate a confidence value of 26% for the beam index #3 (e.g., for the beam 225-c), a confidence value of 25% for the beam index #4 (e.g., for the beam 225-d), and a confidence value of 25% for the beam index #5 (e.g., for the beam 225-e). The subset of confidence values may be indicative of a level of confidence in a predicted viability of the subset of the set of beams. The predicted viability may be based on one or more measurements (e.g., L1-RSRP measurements, L2-RSRP measurements, L1-SINR measurements, L2-SINR measurements) of the set of reference signals. Additionally, a quantity of beam indices included in the subset of beam indices may be based on the subset of confidence values collectively satisfying the confidence threshold. For example, the confidence threshold may be 75% and the subset of beam indices may include three beam indices (e.g., the beam index #3, the beam index #4, and the beam index #5) based on the corresponding confidence values of the top-3 beams collectively satisfying the threshold of 75% (e.g., summing to a value equal to or greater than 75%).

In some examples, a payload associated with the report 235 (e.g., a payload threshold configured at the UE 215 for beam reporting) may be insufficient to report the quantity of top beams that satisfy the confidence threshold. For example, the previous payload of a previous report may accommodate reporting of two beams indices (e.g., and the corresponding confidence values or both the corresponding confidence values and the corresponding received power measurements). In such an example, the UE 215 or the network entity 205 (or both) may update the payload size (or one or more other report parameters) associated with the report 235. For example, the UE 215 or the network entity 205 may update a payload size, a payload structure, a report quantization level, a threshold quantity of beam indices, or any combination thereof. As illustrated in the example of FIG. 2, the UE 215 may transmit a report update indication 245 via the report 235. The report update indication 245 may indicate an update for one or more parameters (e.g., the payload size, the threshold quantity of beams to be reported) associated with the report 235 (or one or more future report). Although the example of FIG. 2 illustrates the report update indication 245 as being included in the report 235, the UE 215 may transmit the report update indication 245 to the network entity 205 via another (e.g., separate) transmission.

In some examples, adaptive CSI reporting for predictive beam management, as described herein, may provide improvements to beam management at the UE 215 or the network entity 205 (or both). For example, one or more aspects of adaptive CSI reporting for predictive beam management may provide a framework for AI/ML beam predictions for the air-interface (e.g., wireless communications) that may lead to increased performance and reduced complexity (e.g., for beam management). The framework may include beam predictions in time-domain or spatial-domain (or both), which may provide for overhead and latency reduction and beam selection accuracy improvements. In some examples, the framework may enable use of AI/ML for characterization and baseline performance evaluations. Accordingly, the framework may provide for AI/ML approaches that may be relatively diverse and support constraints on collaboration levels between the UE 215 and the network entity 205. In some examples, adaptive CSI reporting for predictive beam management, as described herein, may provide for characterization of lifecycle management of an AI/ML model including model training, model deployment, model inference, model monitoring, model updating. In other words, adaptive CSI reporting for predictive beam management may be used for AI-based beam prediction performance monitoring.

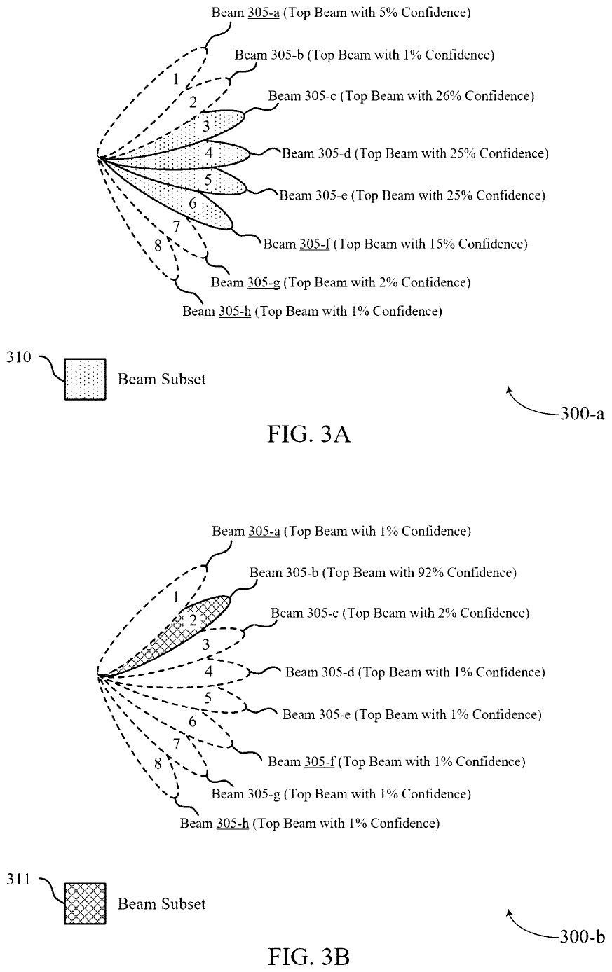

FIGS. 3A and 3B each show an example of a beam prediction diagram 300 that supports adaptive CSI reporting for predictive beam management in accordance with one or more aspects of the present disclosure. In some examples, the beam prediction diagrams 300 (e.g., a beam prediction diagram 300-a, a beam prediction diagram 300-b) may implement or be implemented at one or more aspects of the wireless communications system 100 and the wireless communications system 200. For example, the beam prediction diagrams 300 may be implemented at a UE or a network entity, which may be examples of the corresponding devices illustrated by and described with reference to FIGS. 1 and 2. For example, the UE and the network entity may support a framework for reporting a variable quantity of beams using a single report (e.g., a single CSI report).

In some examples, the network entity may indicate (e.g., via control information, such as may be transmitted via RRC signaling or downlink control information (DCI)) a confidence level threshold (e.g., a confidence threshold) to the UE. Additionally, the network entity may use one or more beams (e.g., a beam 305-a, a beam 305-b, a beam 305-c, a beam 305-d, a beam 305-e, a beam 305-f, a beam 305-g, and a beam 305-h) to transmit a set of reference signals to the UE. The UE may be configured to use a report (e.g., a single CSI report with a fixed payload) to indicate one or more beam indices (e.g., and L1-RSRP or L1-SINR values associated with each of the reported beam indices) of the beams 225 that satisfy the confidence threshold (e.g., a target summation of probabilities, a target confidence constraint). That is, the UE may be configured to report a subset of beam indices corresponding to a subset of the beams 305, in which confidence values associated with the subset of beam indices collectively satisfy the confidence threshold. In some examples, the UE may also be configured to update (e.g., via a MAC-CE or uplink control information (UCI)) one or more parameters used for the CSI report, such as the payload size or payload structure, among other examples of report parameters.

As illustrated in the examples of FIGS. 3A and 3B, the UE may report a subset of beam indices corresponding to a subset of the beams 305 (e.g., the top beams) that satisfy the confidence threshold (e.g., meet a target confidence constraint) using a single report (e.g., a single CSI report with a fixed payload). For example, the UE may be configured with a confidence threshold of 90%. That is, the UE may be configured to report top beams whose confidence values satisfy a confidence threshold of 90% (e.g., whose probabilities sum to 90%). In some examples, however, a payload size (e.g., a threshold payload size) associated with beam reporting (e.g., CSI reporting) at the UE may fail to accommodate a quantity of beam indices that satisfy the confidence threshold (e.g., may fail to accommodate reporting of the quantity of beam indices included in the subset of beam indices). In other words, a payload size (e.g., a threshold payload size) associated with beam reporting (e.g., CSI reporting) at the UE may be less than a payload size used to indicate the quantity of beam indices that satisfy the confidence threshold. For example, a respective confidence value (e.g., probability) obtained by the UE for one or more of the beams 305 may vary over time. That is, respective confidence values of one or more of the beams 305 may improve or degrade (e.g., gradually) over time, which may lead to a change in the quantity of beams indices that satisfy the confidence threshold over time.

In the example of FIG. 3A, the UE may predict that the beam 305-a corresponds to the top beam with a 5% confidence, the beam 305-b corresponds to the top beam with 1% confidence, the beam 305-c corresponds to the top beam with 26% confidence, the beam 305-d corresponds to the top beam with 25% confidence, a beam 305-e corresponds to the top beam with 25% confidence, the beam 305-f corresponds to the top beam with 15% confidence, the beam 305-g corresponds to the top beam with 2% confidence, and the beam 305-h corresponds to the top beam with 1% confidence. In other words, a level of confidence in a predicted viability of the beam 305-a may be 5%, a level of confidence in a predicted viability of the beam 305-b may be 1%, a level of confidence in a predicted viability of the beam 305-c may be 26%, a level of confidence in a predicted viability of the beam 305-d may be 25%, a level of confidence in a predicted viability of the beam 305-e may be 25%, a level of confidence in a predicted viability of the beam 305-f may be 15%, a level of confidence in a predicted viability of the beam 305-g may be 2%, and a level of confidence in a predicted viability of the beam 305-h may be 1%. Accordingly, in the example of FIG. 3A, the UE may report beam indices (e.g., beam IDs) and the corresponding confidence values for the beam 305-c, the beam 305-d, the beam 305-e, and the beam 305-f to satisfy the confidence threshold. That is, the UE may report a subset of beam indices (e.g., and confidence values) corresponding to a beam subset 310 that may include the beam 305-c, the beam 305-d, the beam 305-e, and the beam 305-f. In other words, in the example of FIG. 3A, the subset of the beams 305 (e.g., the beam subset 310) may include the beam 305-c, the beam 305-d, the beam 305-e, and the beam 305-f. Accordingly, the subset of beam indices may include beam index #3, beam index #4, beam index #5, and beam index #6.

In the example of FIG. 3B, the UE may predict that the beam 305-a corresponds to the top beam with a 1% confidence, the beam 305-b corresponds to the top beam with 92% confidence, the beam 305-c corresponds to the top beam with 2% confidence, the beam 305-d corresponds to the top beam with 1% confidence, a beam 305-e corresponds to the top beam with 1% confidence, the beam 305-f corresponds to the top beam with 1% confidence, the beam 305-g corresponds to the top beam with 1% confidence, and the beam 305-h corresponds to the top beam with 1% confidence. In other words, the UE may determine (e.g., an AI/ML model may output) that the beam 305-b has an associated confidence level of 92% and the remaining 7 beams (e.g., the beam 305-a, the beam 305-c, the beam 305-d, the beam 305-e, the beam 305-f, the beam 305-g, and the beam 305-h) have a combined confidence level of 8%. Accordingly, in the example of FIG. 3B, the UE may report the beam index (e.g., the beam ID) and the corresponding confidence values for the beam 305-b to satisfy the confidence threshold. That is, the UE may report a subset of beam indices (e.g., and confidence values) corresponding to a beam subset 311 that may include the beam 305-b. In other words, in the example of FIG. 3B, the subset of the beams 305 (e.g., the beam subset 311) may include the beam 305-b and, accordingly, the subset of beam indices may include beam index #2.

As illustrated in the examples of FIGS. 3A and 3B, the quantity of beams that satisfy the confidence threshold (e.g., the quantity of beam indices included in the subset of beam indices) may vary. Accordingly, the UE or the network entity (or both) may update a payload size (among other report parameters) associated with beam reporting, such that a payload size of a CSI report used in the example of FIG. 3A may accommodate the quantity of beam indices (e.g., four beam indices) corresponding to the beam subset 310 and a payload of another CSI report used in the example of FIG. 3B may accommodate the quantity of beam indices (e.g., one beam index) corresponding to the beam subset 311. That is, in the example of FIG. 3A, the UE or the network entity may update the payload size of the CSI report to accommodate four beam indices. For example, the UE or the network entity may transmit an indication that the CSI report for the beam subset 310 includes four beam indices. In the example of FIG. 3B, the UE or the network entity may update the payload size of the CSI report to accommodate a single beam index. For example, the UE or the network entity may transmit an indication that the CSI report for the beam subset 311 includes a single beam index.

In some examples, the UE may update one or more parameters associated with beam reporting (e.g., a CSI report) using MAC layer signaling or PHY layer signaling. For example, the UE may update one or more parameters associated with a CSI report using a MAC header, a MAC-CE, or UCI. In some examples, the UE may transmit an indication to update one or more parameters associated with the CSI report to the network entity. For example, the UE may include the indication to update one or more parameters in the MAC header of the CSI report, a MAC-CE transmitted with the CSI report, or UCI transmitted with the CSI report. In the example of FIG. 3A, the UE may include an indication in the CSI report for the beam subset 310 (e.g., in the MAC header of the CSI report, in a MAC-CE of the CSI report, in UCI transmitted with the CSI report), that the CSI report includes four beam indices. Additionally, or alternatively, in the example of FIG. 3A, the UE may include an indication in the CSI report for the beam subset 310 (e.g., in the MAC header of the CSI report, in a MAC-CE of the CSI report, in UCI transmitted with the CSI report), of an update for the payload size, the payload structure, or the quantization level of the CSI report that may be based on the CSI report including four beam indices. In the example of FIG. 3B, the UE may include an indication in the CSI report for the beam subset 311 (e.g., in the MAC header of the CSI report, in a MAC-CE of the CSI report, in UCI transmitted with the CSI report), that the CSI report includes a single beam index. Additionally, or alternatively, in the example of FIG. 3A, the UE may include an indication in the CSI report for the beam subset 311 (e.g., in the MAC header of the CSI report, in a MAC-CE of the CSI report, in UCI transmitted with the CSI report), of an update for the payload size, the payload structure, or the quantization level for the CSI report that may be based on the CSI report including a single beam index. In some other examples, the UE may include the indication to update one or more parameters in another uplink message (e.g., a MAC-CE or UCI that may be associated with another transmission). In other words, the UE may update (e.g., autonomously update) the payload size, the payload structure, or the quantity of beams to be reported (e.g., via a CSI report) using a MAC-CE or UCI (e.g., to meet the target confidence constraint).

In some other examples, the network entity may update one or more parameters associated with beam reporting (e.g., a CSI report) using MAC layer signaling or PHY layer signaling. For example, the network entity may update one or more parameters associated with a CSI report using a MAC-CE or DCI. That is, using a MAC-CE or DCI, the network entity may observe reported confidence values (e.g., probabilities) from the UE and may update the payload size, the payload structure, or the quantity of reported beams (e.g., to meet the target confidence constraint). In some examples, the UE may observe the beam confidence values (e.g., probabilities) and recommend a payload size, a payload structure, a quantity of reported beams to the network entity using a MAC-CE or UCI (e.g., before the UE may update the respective parameter based on a network configuration). For example, the UE may be configured to report the top beams whose corresponding confidence values satisfy the confidence threshold of 90% (e.g., probabilities sum to 90%). That is, the quantity of beam indices included in the subset of beam indices may be based on the subset of confidence values (e.g., corresponding to the subset of beam indices) collectively satisfying the confidence threshold of 90%.

In the example of FIG. 3A, the quantity of beam indices included in the subset of beam indices may be four (e.g., beam index #3, beam index #4, beam index #5, and beam index #6). Accordingly, in such an example, the UE or the network entity may update the CSI report size in the MAC-CE (or other control information, such as UCI for the UE or DCI for the network entity) to accommodate for four beam indices. That is, the UE or the network entity may indicate that the CSI report for the beam subset 310 includes four beam indices. In some examples, the UE or the network entity may indicate that the CSI report for the beam subset 310 includes four beam indices and indicate a corresponding payload structure for the four beam indices. In the example of FIG. 3B, the quantity of beam indices included in the subset of beam indices may be one (e.g., beam index #2). Accordingly, in such an example, the UE or the network entity may update the CSI report size in the MAC-CE (or other control information, such as UCI for the UE or DCI for the network entity) to accommodate for one beam index. That is, the UE or the network entity may indicate that the CSI report for the beam subset 311 includes one beam index. In some examples, the UE or the network entity may indicate that the CSI report for the beam subset 311 includes one beam index and indicate a corresponding payload structure for the beam index.

In some examples, the UE may use a variable quantization level for the CSI report, such that the UE may report the top beam indices (e.g., top beam IDs) that satisfy the confidence threshold (e.g., meet the target sum probability constraint). That is, the UE may use a variable quantization level to indicate the confidence values (e.g., probabilities) to accommodate for the variable beam reporting in a fixed payload. In some examples, a quantization level for the CSI report (e.g., variable quantization tables) may be updated through the MAC-CE or the UCI (e.g., MAC or PHY layer signaling used to update one or more other parameters associated with the CSI report). For example, for a same payload size, the UE may use relatively less quantization bits (e.g., a lower quantization level) for reporting beam indices and the corresponding confidence values (e.g., probabilities) for the beam subset 310 (e.g., for the quantity of beams in the example of FIG. 3A that meet the target confidence constraint) and relatively more quantization bits (e.g., a higher quantization level) for reporting the beam index and the corresponding confidence value (e.g., probabilities) for the beam subset 311 (e.g., for the quantity of beams in the example of FIG. 3B that meet the target confidence constraint). In some examples, using a MAC-CE or UCI, the UE may indicate a quantization scheme or one or more quantization levels (or an index of the quantization scheme or the one or more quantization levels from a list of quantization schemes or quantization levels configured at the UE). That is, the UE may be configured with multiple quantization schemes or multiple quantization levels and may indicate an index that corresponds to a quantization scheme (e.g., of multiple configured quantization schemes) or a quantization level (e.g., of multiple quantization levels).

In some examples, the payload size of a CSI report may fail to accommodate the quantity of beam indices that satisfy the confidence threshold (e.g., may fail to meet the target confidence constraint). That is, a payload size configured at the UE for beam reporting (e.g., CSI reporting, such as a payload size that may have been used for a previous CSI report) may be less than a payload size used for reporting the quantity of beam indices whose corresponding confidence values satisfy the confidence threshold. In such examples, the UE may report a portion of the quantity of beam indices via the CSI report (e.g., in accordance with the payload size). Additionally, the UE may report a remaining portion of the quantity of beam indices that satisfy the confidence threshold (e.g., to meet the target confidence constraint) using a MAC-CE. In other words, a quantity of beam indices included in the CSI report may be less than a total quantity of the beam indices whose corresponding confidence values collectively satisfy the confidence threshold. Accordingly, to satisfy the confidence threshold, a remainder of the total quantity not included in the CSI report may be included in a MAC-CE (e.g., transmitted from the UE with the CSI report or in another uplink transmission).

For example, the UE may be configured to report the beam indices (e.g., top beam IDs) of beams whose corresponding confidence values satisfy a confidence threshold of 90% (e.g., whose corresponding probabilities sum to 90%). Additionally, the UE may be configured with a CSI payload size that accommodates transmitting beam indices and corresponding confidence values for three beams (e.g., the top-3 beams of the beams 305). In the example of FIG. 3A, the subset of beams whose corresponding confidence values satisfy the confidence threshold (e.g., the beam subset 310) may include four beams (e.g., the beam 305-c, the beam 305-d, the beam 305-e, and the beam 305-f). Accordingly, the UE may report beam indices and the corresponding confidence values for the beam 305-c, the beam 305-d, and the beam 305-e using the CSI report (e.g., in accordance with the CSI payload size) and the beam index and corresponding confidence value for the beam 305-f using a MAC-CE.

In some other examples, the UE may be configured to report the beam indices (e.g., top beam IDs) and the corresponding confidence values (e.g., and the corresponding L1-RSRP values or L1-SINR values) to satisfy the confidence threshold using a single CSI report, which may be configured with (e.g., conditioned to) a particular payload size (e.g., a fixed payload size). In such examples, in the payload of the CSI report, the UE may indicate the quantity of reported beam indices. For example, the UE may be configured to report the beam indices (e.g., top beam IDs) of beams whose corresponding confidence values collectively satisfy a confidence threshold of 90% (e.g., whose corresponding probabilities sum to 90%) and the CSI payload may be configured for reporting three beam indices (e.g., the top-3 predicted beams) and the corresponding confidence values.

In the example of FIG. 3A, the payload size configured for the CSI report may be smaller than a payload size used to report the quantity of beam indices whose corresponding confidence values satisfy the confidence threshold (e.g., that meet the target confidence constraint). In other words, the quantity of beams that satisfy the confidence threshold may be four beams and the CSI report may be configured for reporting three beams. In such examples, the UE may report a portion of the quantity of beam indices via the CSI report (e.g., in accordance with the payload size) and a remaining portion of the quantity of beam indices that satisfy the confidence threshold may not be excluded from the CSI report. In other words, the quantity of beam indices included in the CSI report may be less than a total quantity of beam indices whose corresponding confidence values collectively satisfy the confidence threshold and a remainder of the total quantity not included in the CSI report may not be transmitted. In some examples, the beam index associated with the lowest confidence value (e.g., lowest the probability) may be excluded from the CSI report (e.g., may not be transmitted). In other words, the confidence values included in the CSI report may be greater in value than the confidence values for each of the remainder of the total quantity not included in the CSI report.

In the example of FIG. 3A, the UE may transmit a CSI report that indicates the beam index #3, the beam index #4, and the beam index #5 and does not include beam index #6 (e.g., based on the beam 305-f corresponding to the lowest confidence value of the confidence values corresponding to the beam subset 310). Additionally, in some examples, the CSI report may indicate that the CSI report includes three beam indices (e.g., includes information for three of the beams 305). That is, the CSI report may indicate a quantity of beams associated with the CSI report. For example, the UE may transmit the CSI report in accordance with the following data structure of Table 1:

TABLE 1

| | | | | | | |
|---|---|---|---|---|---|---|
| 3 Beams | Index #3 | 26% | Index #4 | 25% | Index #5 | 25% |

In the example of FIG. 3B, the payload size of the CSI report may be larger than the quantity of beams whose corresponding confidence values collectively satisfy the confidence threshold (e.g., that meet the target confidence constraint). In such examples, NULL may be transmitted in the corresponding CSI fields. That is, the CSI report may include multiple fields for indicating a quantity of beam indices in accordance with the CSI payload size (e.g., for indicating the subset of beam indices). In some examples, content of one or more of the fields may indicate a null value based on the quantity of beam indices included in the subset of beam indices being less than a threshold quantity of beam indices associated with the CSI report (e.g., based on the payload size of the CSI report being larger than the quantity of beams whose corresponding confidence values collectively satisfy the confidence threshold). In the example of FIG. 3B, the threshold quantity of beams may be three (e.g., the payload size of the CSI report may accommodate for beam indices and corresponding confidence values of the top-3 beams) and the quantity of beams whose corresponding confidence values satisfy the confidence threshold may be one (e.g., the beam subset 311 may include 1 beam). Accordingly, the UE may transmit a CSI report that indicates the beam index #2 and NULL for remaining beam fields. Additionally, in some examples, the CSI report may indicate that the CSI report includes one beam. For example, the UE may transmit the CSI report in accordance with the following data structure of Table 2:

TABLE 2

| | | | | | | |
|---|---|---|---|---|---|---|
| 1 Beam | Index #2 | 92% | NULL | NULL | NULL | NULL |

In some examples, the soft beam prediction information may be conveyed in a single CSI report, which may lead to faster reporting (e.g., to meet stringent latency constraints, such as may be associated with of URLLC and other latency-critical applications). Additionally, such reporting may reduce computation constraints at the UE. For example, the UE may refrain from computing the confidence value (e.g., probabilities) for low probability beams, which may lead to reduce complexity at the UE, among other possible benefits.

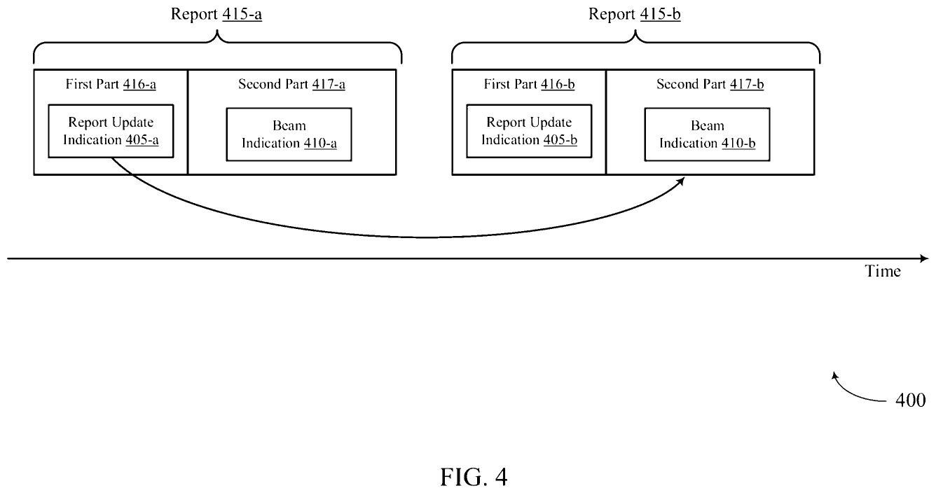

FIG. 4 shows an example of a timing diagram 400 that supports adaptive CSI reporting for predictive beam management in accordance with one or more aspects of the present disclosure. In some examples, the timing diagram 400 may implement or be implemented at one or more aspects of the wireless communications system 100, the wireless communications system 200, and the beam prediction diagrams 300. For example, the timing diagram 400 may be implemented at a UE or a network entity, which may be examples of the corresponding devices illustrated by and described with reference to FIGS. 1, 2, 3A, and 3B.

The UE and the network entity may support a framework for reporting a variable quantity of beams using a single report (e.g., a single CSI report). For example, the UE may be configured to report information (e.g., beam indices, corresponding confidence values, corresponding received power metrics) associated with one or more beams whose corresponding confidence values satisfy a confidence threshold (e.g., that meet a target confidence constraint) using a single CSI report. That is, the UE may report a subset of beam indices, a corresponding subset of confidence values, and a corresponding received power metric for each of the subset of beam indices. In such an example, the subset of beam indices may correspond to a subset of a set of beams used to transmit a set of reference signals to the UE and the subset of received power metrics may be based on one or more measurements of a subset the set of reference signals associated with the subset of the set of beams.

In some examples, the CSI report may include multiple (e.g., two) parts. For example, the CSI report (e.g., a report 415-a, a report 415-b) may include a first part (e.g., a first part 416-a, a first part 416-b) and a second part (e.g., a second part 417-a, a second part 417-b). In other words, the reports 415 may have a payload size (e.g., total fixed payload size) and include two parts (e.g., the first parts 416 and the second parts 417). A payload of the first parts 416 may indicate one or more parameters for another (e.g., a future) report. That is, a future CSI report payload size and structure information (e.g., report details, including a quantization level) may be indicated in the first parts 416. In other words, the first parts 416 may indicate an update for one or more parameters and the one or more parameters may include a payload size, a payload structure, a report quantization level, a threshold quantity of beam indices, or any combination thereof. A payload of the second parts 417 may indicate beam indices (or another type of beam ID) and corresponding confidence levels (e.g., and corresponding receive power metrics, such as L1-RSRSP values or L1-SINR values) of one or more beams associated with a current report. That is, a payload of the second parts 417 may indicate beam indices and corresponding confidence levels of one or more beams being reported via a current report. In other words, a payload of a first part of a current CSI report (e.g., the first part 416-a, the first part 416-b) may indicate a payload size or structure, or both, for a future CSI report. Additionally, a payload (e.g., the actual payload) of a second part of the current CSI report (e.g., the second part 417-a, the second part 417-b) may indicate beam indices and corresponding confidence levels of one or more top beams being reported via the current CSI report. The second parts 417 of the current CSI report may indicate the beam indices (e.g., indices of the top beams) and the corresponding confidence levels in accordance with a payload size (e.g., a fixed payload size) reported in a previous CSI report.

For example, the UE may transmit the report 415-a to the network entity. The first part 416-a of the report 415-a may include a quantity of bits (e.g., a fixed quantity of bits) that indicate report information (e.g., report details, such as a payload size and structure) for the report 415-b (e.g., a future CSI report). For example, the first part 416-a may include a report update indication 405-a that may indicate an update (or recommendation) of one or more parameters for the report 415-b. Additionally, the second part 417-a of the report 415-a may include a quantity of bits that may be based on an indication transmitted via a first part of a previous CSI report (e.g., a previous CSI report use to report a quantity (k) of top beams, a previous CIS report that indicates a top-k beam indices and corresponding confidence levels). For example, the second part 417-a of the report 415-a may include a beam indication 410-a. The beam indication 410-a may indicate beam indices and corresponding confidence levels (e.g., and corresponding receive power metrics, such as L1-RSRSP values or L1-SINR values) for one or more top beams being reported via the report 415-a. That is, the second part 417-a may indicate the top-k beam indices and the corresponding confidence levels for the top-k beams being reported via the report 415-a. In some examples, the report update indication 405-a may be based on a quantity of beam indices expected to be indicated via the report 415-b (e.g., expected to be included in a subset of beam indices for the report 415-b) being different from the quantity of beam indices indicated via the second part 417-a (e.g., the quantity be beam indices included in the subset of beam indices for the report 415-a).

After transmitting the report 415-a (e.g., at a future time instance), the UE may transmit the report 415-b in accordance with the report update indication 405-a (e.g., in accordance with the one or more updated parameters). For example, the first part 416-b of the report 415-b may include a report update indication 405-b. The report update indication 405-b may indicate an update (or recommendation) of one or more parameters for a future report (e.g., a report transmitted after the report 415-b). That is, the first part 416-b may include a quantity of bits (e.g., a fixed quantity of bits, a same quantity of bits as may be included in the first part 416-a) that indicate report information (e.g., report details, such as a payload size and structure) for a future CSI report. Additionally, the second part 417-b of the report 415-b may include an updated quantity of bits (e.g., a different quantity of bits than the quantity of bits that may be included in the second part 417-a) based on the report update indication 405-a. That is, the second part 417-b of the report 415-b may include an updated quantity of that may be based on a configuration indicated via a first part of a previous CSI report including the top-k beam indices and the corresponding confidence levels (e.g., indicated via the first part 416-a of the report 415-a). For example, the second part 417-b may include a beam indication 410-b may indicate beam indices and corresponding confidence levels (e.g., and corresponding receive power metrics, such as L1-RSRSP values or L1-SINR values) for one or more beams (e.g., top beams) being reported via the report 415-b. That is, the second part 417-b may indicate the top-k beam indices and the corresponding confidence levels for the top-k beams being reported via the report 415-b. In some examples, using a part of a CSI report to update report parameters for future CSI report may reduce latency and increase a performance of CSI reporting, among other benefits.

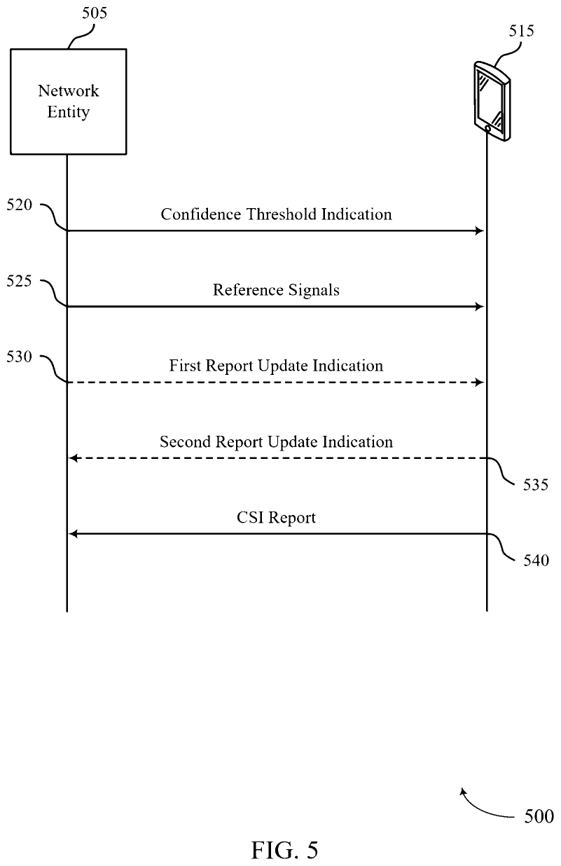

FIG. 5 shows an example of a process flow 500 that supports adaptive CSI reporting for predictive beam management in accordance with one or more aspects of the present disclosure. In some examples, the process flow 500 may implement one or more aspects of wireless communications system 100, the wireless communications system 200, the beam prediction diagrams 300, and the timing diagram 400. For example, the process flow 500 may include example operations associated a network entity 505 and a UE 515, which may be examples of the corresponding devices illustrated by and described with reference to FIGS. 1, 2, 3A, 3B, and 4. The operations performed by the network entity 505 and the UE 515 may support improvements to communications between the UE 515 and the network entity 505, among other benefits. In the following description of the process flow 500, the operations between the UE 515 and the network entity 505 may occur in a different order than the example order shown. Additionally, or alternatively, the operations performed by the UE 515 and the network entity 505 may be performed in different orders or at different times. Some operations may also be omitted or combined. The UE 515 and the network entity 505 may support a framework for reporting a variable quantity of beams using a single report (e.g., a single CSI report).

At 520, the UE 515 may receive a confidence level threshold indication from the network entity 505. The confidence threshold indication may be an example of a confidence threshold indication illustrated by and described with reference to FIG. 2. For example, the confidence threshold indication may include control information that indicates a confidence level threshold (e.g., a confidence threshold) for beam reporting.

At 525, the UE 515 may receive a set of reference signals from the network entity 505. The set of reference signals may be an example of a set of reference signals as described with reference to FIGS. 2, 3A, 3B, and 4. For example, the set of reference signals may be associated with (e.g., transmitted via) a set of beams used for wireless communication (e.g., downlink communication) at the network entity 505. In such an example, each beam of the set of beams corresponds to a respective beam index. In some examples, the UE 515 may communicate, with the network entity 505, an indication of an update for at least one parameter associate with the report. For example, the UE 515 may communicate the indication of the update based on the quantity of beam indices included in the subset of beam indices for the report being different from a previous quantity of beam indices included in the subset of beam indices for a previous report.

In some examples, at 530, the UE 515 may receive a first report update indication from the network entity 505. The first report updated indication may be an example of a report update indication illustrated by and described with reference to FIGS. 3A, 3B, and 4. For example, the first report update indication may indicate the update for the at least one parameter. In some examples, the first report updated indication may be included in a MAC-CE or DCI. The UE 515 may, in some examples, transmit a recommendation for the update to the network entity 505. In such examples, the updated indicated via the first report update indication may be based on the recommendation provided by the UE 515.

In some other examples, at 535, the UE 515 may transmit a second report update indication to the network entity 505. The second report updated indication may be an example of a report update indication illustrated by and described with reference to FIGS. 3A, 3B, and 4. For example, the second report update indication may indicate the update for the at least one parameter. In some examples, the second report updated indication may be included in a MAC-CE or UCI. For example, the second report updated indication may be included in a MAC-CE or UCI transmitted with a CSI report (e.g., transmitted at 540) or via another uplink transmission.

At 540, the UE 515 may transmit the CSI report to the network entity 505. The CSI report may be an example of a report, such as a CSI report, illustrated by and described with reference to FIGS. 2, 3A, 3B, and 4. For example, the CSI report may indicate a subset of beam indices corresponding to a subset of the set of beams and may also indicate a corresponding confidence value for each of the subset of beam indices. In some examples, the subset of confidence values may be examples of confidence values illustrated by and described with reference to FIGS. 2, 3A, 3B, and 4. For example, the subset of confidence values may be indicative of a level of confidence in a predicted viability of the subset of the set of beams. In some examples, the predicted viability may be based on one or more measurements of the set of reference signals. Additionally, in some examples, a quantity of beam indices included in the subset of beam indices may be based on the subset of confidence values collectively satisfying the confidence level threshold. In some examples, be reporting the subset of beam indices via the CSI report, the UE 515 may improve beam management at the network entity 505, among other benefits.

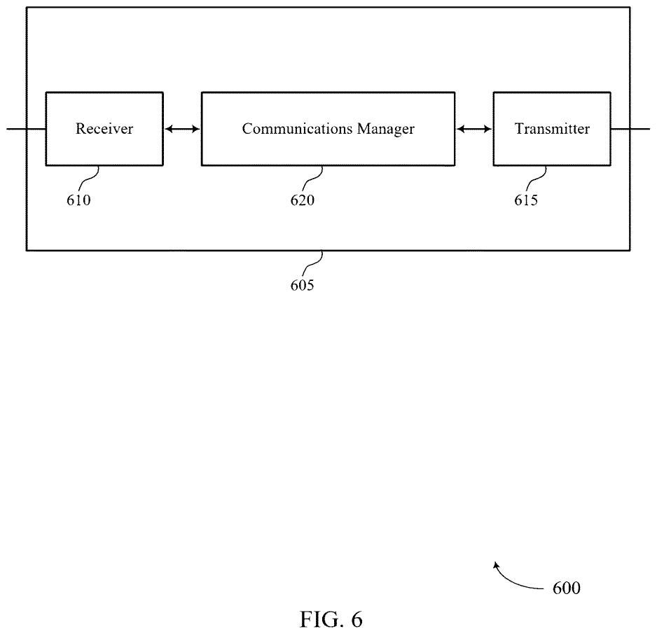

FIG. 6 shows a block diagram 600 of a device 605 that supports adaptive CSI reporting for predictive beam management in accordance with one or more aspects of the present disclosure. The device 605 may be an example of aspects of a UE 115 as described herein. The device 605 may include a receiver 610, a transmitter 615, and a communications manager 620. The device 605 may also include a processor. Each of these components may be in communication with one another (e.g., via one or more buses).

The receiver 610 may provide a means for receiving information such as packets, user data, control information, or any combination thereof associated with various information channels (e.g., control channels, data channels, information channels related to adaptive CSI reporting for predictive beam management). Information may be passed on to other components of the device 605. The receiver 610 may utilize a single antenna or a set of multiple antennas.

The transmitter 615 may provide a means for transmitting signals generated by other components of the device 605. For example, the transmitter 615 may transmit information such as packets, user data, control information, or any combination thereof associated with various information channels (e.g., control channels, data channels, information channels related to adaptive CSI reporting for predictive beam management). In some examples, the transmitter 615 may be co-located with a receiver 610 in a transceiver module. The transmitter 615 may utilize a single antenna or a set of multiple antennas.

The communications manager 620, the receiver 610, the transmitter 615, or various combinations thereof or various components thereof may be examples of means for performing various aspects of adaptive CSI reporting for predictive beam management as described herein. For example, the communications manager 620, the receiver 610, the transmitter 615, or various combinations or components thereof may support a method for performing one or more of the functions described herein.

In some examples, the communications manager 620, the receiver 610, the transmitter 615, or various combinations or components thereof may be implemented in hardware (e.g., in communications management circuitry). The hardware may include a processor, a digital signal processor (DSP), a central processing unit (CPU), an application-specific integrated circuit (ASIC), a field-programmable gate array (FPGA) or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 620, the receiver 610, the transmitter 615, or various combinations or components thereof may be implemented in code (e.g., as communications management software or firmware) executed by a processor. If implemented in code executed by a processor, the functions of the communications manager 620, the receiver 610, the transmitter 615, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 620 may be configured to perform various operations (e.g., receiving, obtaining, monitoring, outputting, transmitting) using or otherwise in cooperation with the receiver 610, the transmitter 615, or both. For example, the communications manager 620 may receive information from the receiver 610, send information to the transmitter 615, or be integrated in combination with the receiver 610, the transmitter 615, or both to obtain information, output information, or perform various other operations as described herein.

The communications manager 620 may support wireless communications at a UE (e.g., the device 605) in accordance with examples as disclosed herein. For example, the communications manager 620 is capable of, configured to, or operable to support a means for receiving, from a network entity, control information that indicates a confidence level threshold for beam reporting. The communications manager 620 is capable of, configured to, or operable to support a means for receiving, from the network entity, a set of reference signals associated with a set of beams used for wireless communication at the network entity, where each beam of the set of beams corresponds to a respective beam index. The communications manager 620 is capable of, configured to, or operable to support a means for transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

By including or configuring the communications manager 620 in accordance with examples as described herein, the device 605 (e.g., a processor controlling or otherwise coupled with the receiver 610, the transmitter 615, the communications manager 620, or a combination thereof) may support techniques for reduced processing and more efficient utilization of communication resources.

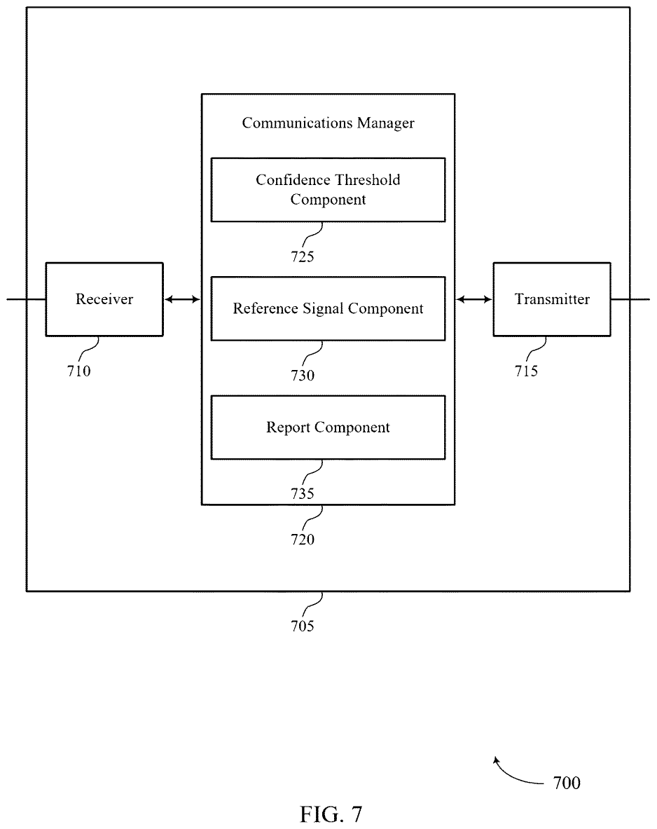

FIG. 7 shows a block diagram 700 of a device 705 that supports adaptive CSI reporting for predictive beam management in accordance with one or more aspects of the present disclosure. The device 705 may be an example of aspects of a device 605 or a UE 115 as described herein. The device 705 may include a receiver 710, a transmitter 715, and a communications manager 720. The device 705 may also include a processor. Each of these components may be in communication with one another (e.g., via one or more buses).

The receiver 710 may provide a means for receiving information such as packets, user data, control information, or any combination thereof associated with various information channels (e.g., control channels, data channels, information channels related to adaptive CSI reporting for predictive beam management). Information may be passed on to other components of the device 705. The receiver 710 may utilize a single antenna or a set of multiple antennas.

The transmitter 715 may provide a means for transmitting signals generated by other components of the device 705. For example, the transmitter 715 may transmit information such as packets, user data, control information, or any combination thereof associated with various information channels (e.g., control channels, data channels, information channels related to adaptive CSI reporting for predictive beam management). In some examples, the transmitter 715 may be co-located with a receiver 710 in a transceiver module. The transmitter 715 may utilize a single antenna or a set of multiple antennas.

The device 705, or various components thereof, may be an example of means for performing various aspects of adaptive CSI reporting for predictive beam management as described herein. For example, the communications manager 720 may include a confidence threshold component 725, a reference signal component 730, a report component 735, or any combination thereof. The communications manager 720 may be an example of aspects of a communications manager 620 as described herein. In some examples, the communications manager 720, or various components thereof, may be configured to perform various operations (e.g., receiving, obtaining, monitoring, outputting, transmitting) using or otherwise in cooperation with the receiver 710, the transmitter 715, or both. For example, the communications manager 720 may receive information from the receiver 710, send information to the transmitter 715, or be integrated in combination with the receiver 710, the transmitter 715, or both to obtain information, output information, or perform various other operations as described herein.

The communications manager 720 may support wireless communications at a UE (e.g., the device 705) in accordance with examples as disclosed herein. The confidence threshold component 725 is capable of, configured to, or operable to support a means for receiving, from a network entity, control information that indicates a confidence level threshold for beam reporting. The reference signal component 730 is capable of, configured to, or operable to support a means for receiving, from the network entity, a set of reference signals associated with a set of beams used for wireless communication at the network entity, where each beam of the set of beams corresponds to a respective beam index. The report component 735 is capable of, configured to, or operable to support a means for transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

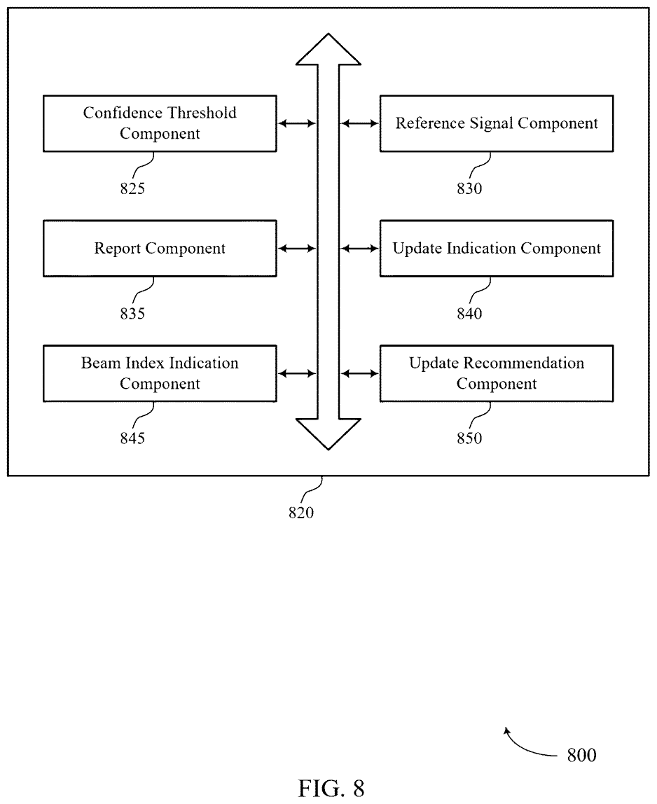

FIG. 8 shows a block diagram 800 of a communications manager 820 that supports adaptive CSI reporting for predictive beam management in accordance with one or more aspects of the present disclosure. The communications manager 820 may be an example of aspects of a communications manager 620, a communications manager 720, or both, as described herein. The communications manager 820, or various components thereof, may be an example of means for performing various aspects of adaptive CSI reporting for predictive beam management as described herein. For example, the communications manager 820 may include a confidence threshold component 825, a reference signal component 830, a report component 835, an update indication component 840, a beam index indication component 845, an update recommendation component 850, or any combination thereof. Each of these components may communicate, directly or indirectly, with one another (e.g., via one or more buses).

The communications manager 820 may support wireless communications at a UE in accordance with examples as disclosed herein. The confidence threshold component 825 is capable of, configured to, or operable to support a means for receiving, from a network entity, control information that indicates a confidence level threshold for beam reporting. The reference signal component 830 is capable of, configured to, or operable to support a means for receiving, from the network entity, a set of reference signals associated with a set of beams used for wireless communication at the network entity, where each beam of the set of beams corresponds to a respective beam index. The report component 835 is capable of, configured to, or operable to support a means for transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

In some examples, the update indication component 840 is capable of, configured to, or operable to support a means for communicating, with the network entity, an indication of an update for at least one parameter associated with the report based on the quantity of beam indices included in the subset of beam indices for the report being different from a previous quantity of beam indices included in the subset of beam indices for a previous report.

In some examples, to support communicating the indication, the update indication component 840 is capable of, configured to, or operable to support a means for transmitting, to the network entity, the indication of the update for the at least one parameter, the indication being included with the report and in a MAC-CE or UCI.

In some examples, to support communicating the indication, the update indication component 840 is capable of, configured to, or operable to support a means for receiving, from the network entity, the indication of the update for the at least one parameter, the indication being included in a MAC-CE or DCI. In some examples, the update recommendation component 850 is capable of, configured to, or operable to support a means for transmitting, to the network entity, a recommendation for the update of the at least one parameter, where the update is based on the recommendation.

In some examples, the at least one parameter includes a payload size, a payload structure, a report quantization level, a threshold quantity of beam indices, or any combination thereof. In some examples, a quantization level used to indicate the subset of beam indices and the corresponding confidence value for each of the subset of beam indices is variable and is based on the quantity of beam indices included in the subset of beam indices.

In some examples, the quantity of beam indices included in the report is less than a total quantity of the subset of confidence values collectively satisfying the confidence level threshold. In some examples, a remainder of the total quantity not included in the report is included in a MAC-CE. In some examples, the confidence values included in the report are greater in value than the confidence values for each of the remainder of the total quantity not included in the report.

In some examples, the quantity of beam indices included in the report is less than a total quantity of the subset of confidence values collectively satisfying the confidence level threshold. In some examples, a remainder of the total quantity not included in the report is not transmitted.

In some examples, the report includes a set of multiple fields for indicating the subset of beam indices. In some examples, content of at least one field of the set of multiple fields indicates a null value based on the quantity of beam indices included in the subset of beam indices being less than a threshold quantity of beam indices associated with the report. In some examples, the report indicates a quantity of beams associated with the report.

In some examples, the update indication component 840 is capable of, configured to, or operable to support a means for transmitting, to the network entity, an indication of an update for at least one parameter associated with the report based on a quantity of beam indices expected to be included in the subset of beam indices for a future report being different from the quantity of beam indices included in the subset of beam indices for the report.

In some examples, to support transmitting the indication, the update indication component 840 is capable of, configured to, or operable to support a means for transmitting, in a first part of the report, the indication of the update for the at least one parameter. In some examples, to support transmitting the indication, the beam index indication component 845 is capable of, configured to, or operable to support a means for transmitting, in a second part of the report, information that indicates the subset of beam indices and the corresponding confidence value for each of the subset of beam indices.

In some examples, the report indicates a corresponding received power metric for each of the subset of beam indices, the subset of received power metrics based on one or more measurements of a subset the set of reference signals associated with the subset of the set of beams.

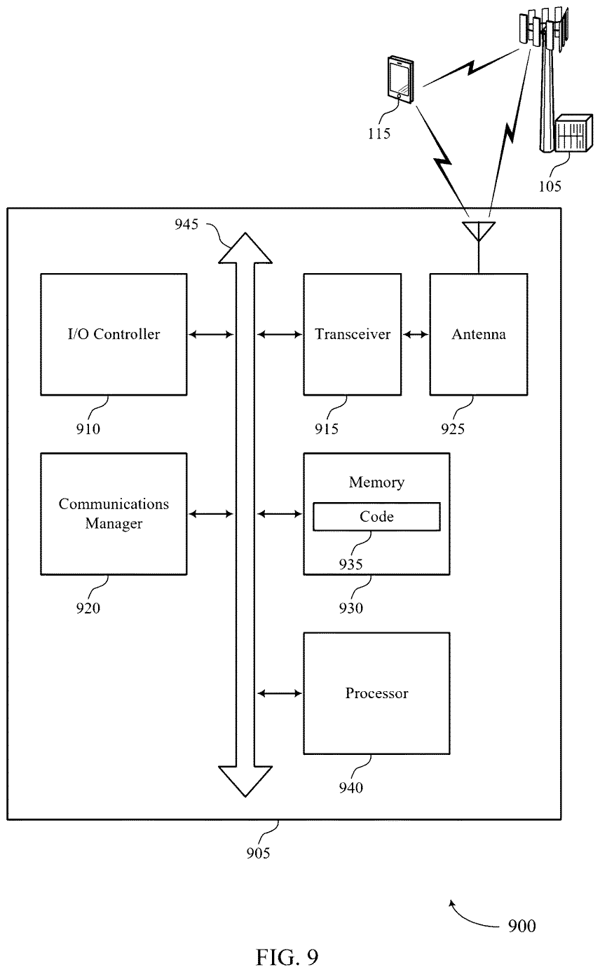

FIG. 9 shows a diagram of a system 900 including a device 905 that supports adaptive CSI reporting for predictive beam management in accordance with one or more aspects of the present disclosure. The device 905 may be an example of or include the components of a device 605, a device 705, or a UE 115 as described herein. The device 905 may communicate (e.g., wirelessly) with one or more network entities 105, one or more UEs 115, or any combination thereof. The device 905 may include components for bi-directional voice and data communications including components for transmitting and receiving communications, such as a communications manager 920, an input/output (I/O) controller 910, a transceiver 915, an antenna 925, a memory 930, code 935, and a processor 940. These components may be in electronic communication or otherwise coupled (e.g., operatively, communicatively, functionally, electronically, electrically) via one or more buses (e.g., a bus 945).

The I/O controller 910 may manage input and output signals for the device 905. The I/O controller 910 may also manage peripherals not integrated into the device 905. In some cases, the I/O controller 910 may represent a physical connection or port to an external peripheral. In some cases, the I/O controller 910 may utilize an operating system such as iOS®, ANDROID®, MS-DOS®, MS-WINDOWS®, OS/2®, UNIX®, LINUX®, or another known operating system. Additionally, or alternatively, the I/O controller 910 may represent or interact with a modem, a keyboard, a mouse, a touchscreen, or a similar device. In some cases, the I/O controller 910 may be implemented as part of a processor, such as the processor 940. In some cases, a user may interact with the device 905 via the I/O controller 910 or via hardware components controlled by the I/O controller 910.

In some cases, the device 905 may include a single antenna 925. However, in some other cases, the device 905 may have more than one antenna 925, which may be capable of concurrently transmitting or receiving multiple wireless transmissions. The transceiver 915 may communicate bi-directionally, via the one or more antennas 925, wired, or wireless links as described herein. For example, the transceiver 915 may represent a wireless transceiver and may communicate bi-directionally with another wireless transceiver. The transceiver 915 may also include a modem to modulate the packets, to provide the modulated packets to one or more antennas 925 for transmission, and to demodulate packets received from the one or more antennas 925. The transceiver 915, or the transceiver 915 and one or more antennas 925, may be an example of a transmitter 615, a transmitter 715, a receiver 610, a receiver 710, or any combination thereof or component thereof, as described herein.

The memory 930 may include random access memory (RAM) and read-only memory (ROM). The memory 930 may store computer-readable, computer-executable code 935 including instructions that, when executed by the processor 940, cause the device 905 to perform various functions described herein. The code 935 may be stored in a non-transitory computer-readable medium such as system memory or another type of memory. In some cases, the code 935 may not be directly executable by the processor 940 but may cause a computer (e.g., when compiled and executed) to perform functions described herein. In some cases, the memory 930 may contain, among other things, a basic I/O system (BIOS) which may control basic hardware or software operation such as the interaction with peripheral components or devices.

The processor 940 may include an intelligent hardware device (e.g., a general-purpose processor, a DSP, a CPU, a microcontroller, an ASIC, an FPGA, a programmable logic device, a discrete gate or transistor logic component, a discrete hardware component, or any combination thereof). In some cases, the processor 940 may be configured to operate a memory array using a memory controller. In some other cases, a memory controller may be integrated into the processor 940. The processor 940 may be configured to execute computer-readable instructions stored in a memory (e.g., the memory 930) to cause the device 905 to perform various functions (e.g., functions or tasks supporting adaptive CSI reporting for predictive beam management). For example, the device 905 or a component of the device 905 may include a processor 940 and memory 930 coupled with or to the processor 940, the processor 940 and memory 930 configured to perform various functions described herein.

The communications manager 920 may support wireless communications at a UE (e.g., the device 905) in accordance with examples as disclosed herein. For example, the communications manager 920 is capable of, configured to, or operable to support a means for receiving, from a network entity, control information that indicates a confidence level threshold for beam reporting. The communications manager 920 is capable of, configured to, or operable to support a means for receiving, from the network entity, a set of reference signals associated with a set of beams used for wireless communication at the network entity, where each beam of the set of beams corresponds to a respective beam index. The communications manager 920 is capable of, configured to, or operable to support a means for transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

By including or configuring the communications manager 920 in accordance with examples as described herein, the device 905 may support techniques for improved communication reliability, reduced latency, improved user experience related to reduced processing, more efficient utilization of communication resources, and improved utilization of processing capability.

In some examples, the communications manager 920 may be configured to perform various operations (e.g., receiving, monitoring, transmitting) using or otherwise in cooperation with the transceiver 915, the one or more antennas 925, or any combination thereof. Although the communications manager 920 is illustrated as a separate component, in some examples, one or more functions described with reference to the communications manager 920 may be supported by or performed by the processor 940, the memory 930, the code 935, or any combination thereof. For example, the code 935 may include instructions executable by the processor 940 to cause the device 905 to perform various aspects of adaptive CSI reporting for predictive beam management as described herein, or the processor 940 and the memory 930 may be otherwise configured to perform or support such operations.

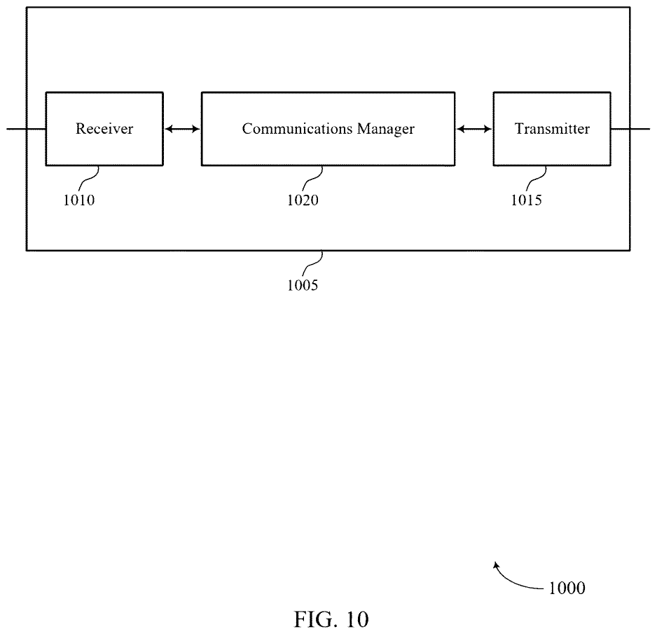

FIG. 10 shows a block diagram 1000 of a device 1005 that supports adaptive CSI reporting for predictive beam management in accordance with one or more aspects of the present disclosure. The device 1005 may be an example of aspects of a network entity 105 as described herein. The device 1005 may include a receiver 1010, a transmitter 1015, and a communications manager 1020. The device 1005 may also include a processor. Each of these components may be in communication with one another (e.g., via one or more buses).

The receiver 1010 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1005. In some examples, the receiver 1010 may support obtaining information by receiving signals via one or more antennas. Additionally, or alternatively, the receiver 1010 may support obtaining information by receiving signals via one or more wired (e.g., electrical, fiber optic) interfaces, wireless interfaces, or any combination thereof.

The transmitter 1015 may provide a means for outputting (e.g., transmitting, providing, conveying, sending) information generated by other components of the device 1005. For example, the transmitter 1015 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1015 may support outputting information by transmitting signals via one or more antennas. Additionally, or alternatively, the transmitter 1015 may support outputting information by transmitting signals via one or more wired (e.g., electrical, fiber optic) interfaces, wireless interfaces, or any combination thereof. In some examples, the transmitter 1015 and the receiver 1010 may be co-located in a transceiver, which may include or be coupled with a modem.

The communications manager 1020, the receiver 1010, the transmitter 1015, or various combinations thereof or various components thereof may be examples of means for performing various aspects of adaptive CSI reporting for predictive beam management as described herein. For example, the communications manager 1020, the receiver 1010, the transmitter 1015, or various combinations or components thereof may support a method for performing one or more of the functions described herein.

In some examples, the communications manager 1020, the receiver 1010, the transmitter 1015, or various combinations or components thereof may be implemented in hardware (e.g., in communications management circuitry). The hardware may include a processor, a DSP, a CPU, an ASIC, an FPGA or other programmable logic device, a microcontroller, discrete gate or transistor logic, discrete hardware components, or any combination thereof configured as or otherwise supporting a means for performing the functions described in the present disclosure. In some examples, a processor and memory coupled with the processor may be configured to perform one or more of the functions described herein (e.g., by executing, by the processor, instructions stored in the memory).

Additionally, or alternatively, in some examples, the communications manager 1020, the receiver 1010, the transmitter 1015, or various combinations or components thereof may be implemented in code (e.g., as communications management software or firmware) executed by a processor. If implemented in code executed by a processor, the functions of the communications manager 1020, the receiver 1010, the transmitter 1015, or various combinations or components thereof may be performed by a general-purpose processor, a DSP, a CPU, an ASIC, an FPGA, a microcontroller, or any combination of these or other programmable logic devices (e.g., configured as or otherwise supporting a means for performing the functions described in the present disclosure).

In some examples, the communications manager 1020 may be configured to perform various operations (e.g., receiving, obtaining, monitoring, outputting, transmitting) using or otherwise in cooperation with the receiver 1010, the transmitter 1015, or both. For example, the communications manager 1020 may receive information from the receiver 1010, send information to the transmitter 1015, or be integrated in combination with the receiver 1010, the transmitter 1015, or both to obtain information, output information, or perform various other operations as described herein.

The communications manager 1020 may support wireless communications at a network entity (e.g., the device 1005) in accordance with examples as disclosed herein. For example, the communications manager 1020 is capable of, configured to, or operable to support a means for outputting control information that indicating a confidence level threshold for beam reporting. The communications manager 1020 is capable of, configured to, or operable to support a means for outputting a set of reference signals associated with a set of beams used for wireless communication at the network entity, where each beam of the set of beams corresponds to a respective beam index. The communications manager 1020 is capable of, configured to, or operable to support a means for obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

By including or configuring the communications manager 1020 in accordance with examples as described herein, the device 1005 (e.g., a processor controlling or otherwise coupled with the receiver 1010, the transmitter 1015, the communications manager 1020, or a combination thereof) may support techniques for reduced processing and more efficient utilization of communication resources.

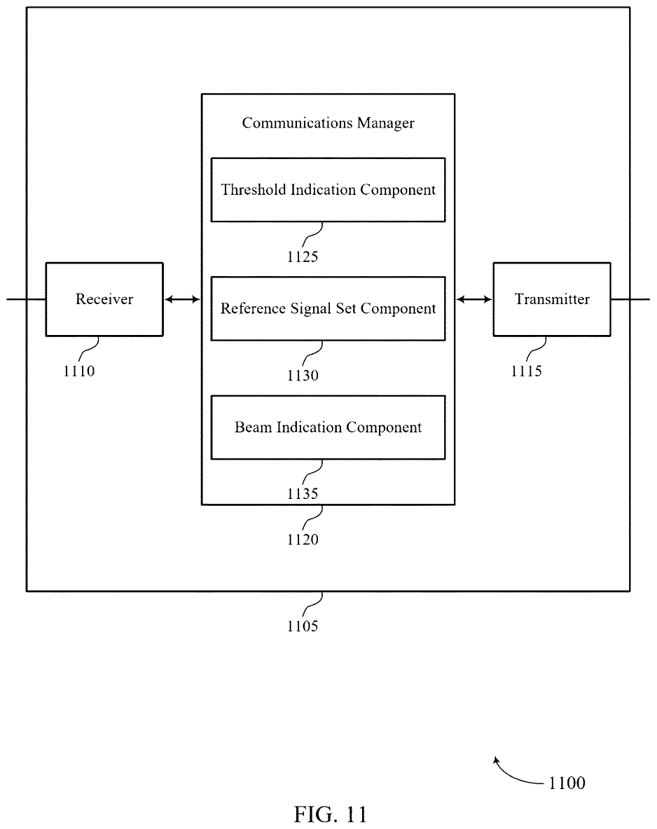

FIG. 11 shows a block diagram 1100 of a device 1105 that supports adaptive CSI reporting for predictive beam management in accordance with one or more aspects of the present disclosure. The device 1105 may be an example of aspects of a device 1005 or a network entity 105 as described herein. The device 1105 may include a receiver 1110, a transmitter 1115, and a communications manager 1120. The device 1105 may also include a processor. Each of these components may be in communication with one another (e.g., via one or more buses).

The receiver 1110 may provide a means for obtaining (e.g., receiving, determining, identifying) information such as user data, control information, or any combination thereof (e.g., I/Q samples, symbols, packets, protocol data units, service data units) associated with various channels (e.g., control channels, data channels, information channels, channels associated with a protocol stack). Information may be passed on to other components of the device 1105. In some examples, the receiver 1110 may support obtaining information by receiving signals via one or more antennas. Additionally, or alternatively, the receiver 1110 may support obtaining information by receiving signals via one or more wired (e.g., electrical, fiber optic) interfaces, wireless interfaces, or any combination thereof.

The transmitter 1115 may provide a means for outputting (e.g., transmitting, providing, conveying, sending) information generated by other components of the device 1105. For example, the transmitter 1115 may output information such as user data, control information, or any combination thereof (e.g., I/Q samples, symbols, packets, protocol data units, service data units) associated with various channels (e.g., control channels, data channels, information channels, channels associated with a protocol stack). In some examples, the transmitter 1115 may support outputting information by transmitting signals via one or more antennas. Additionally, or alternatively, the transmitter 1115 may support outputting information by transmitting signals via one or more wired (e.g., electrical, fiber optic) interfaces, wireless interfaces, or any combination thereof. In some examples, the transmitter 1115 and the receiver 1110 may be co-located in a transceiver, which may include or be coupled with a modem.

The device 1105, or various components thereof, may be an example of means for performing various aspects of adaptive CSI reporting for predictive beam management as described herein. For example, the communications manager 1120 may include a threshold indication component 1125, a reference signal set component 1130, a beam indication component 1135, or any combination thereof. The communications manager 1120 may be an example of aspects of a communications manager 1020 as described herein. In some examples, the communications manager 1120, or various components thereof, may be configured to perform various operations (e.g., receiving, obtaining, monitoring, outputting, transmitting) using or otherwise in cooperation with the receiver 1110, the transmitter 1115, or both. For example, the communications manager 1120 may receive information from the receiver 1110, send information to the transmitter 1115, or be integrated in combination with the receiver 1110, the transmitter 1115, or both to obtain information, output information, or perform various other operations as described herein.

The communications manager 1120 may support wireless communications at a network entity (e.g., the device 1105) in accordance with examples as disclosed herein. The threshold indication component 1125 is capable of, configured to, or operable to support a means for outputting control information that indicates a confidence level threshold for beam reporting. The reference signal set component 1130 is capable of, configured to, or operable to support a means for outputting a set of reference signals associated with a set of beams used for wireless communication at the network entity, where each beam of the set of beams corresponds to a respective beam index. The beam indication component 1135 is capable of, configured to, or operable to support a means for obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

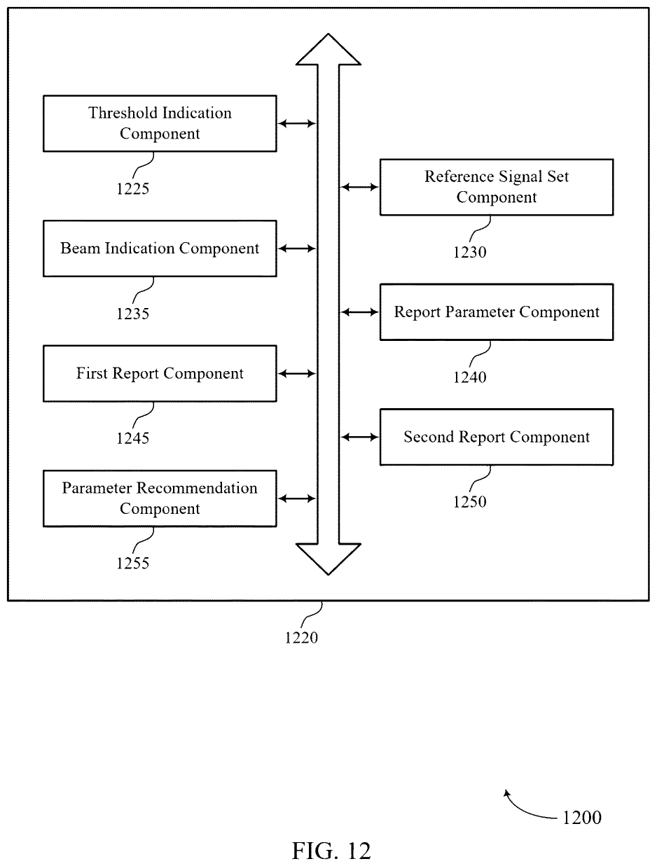

FIG. 12 shows a block diagram 1200 of a communications manager 1220 that supports adaptive CSI reporting for predictive beam management in accordance with one or more aspects of the present disclosure. The communications manager 1220 may be an example of aspects of a communications manager 1020, a communications manager 1120, or both, as described herein. The communications manager 1220, or various components thereof, may be an example of means for performing various aspects of adaptive CSI reporting for predictive beam management as described herein. For example, the communications manager 1220 may include a threshold indication component 1225, a reference signal set component 1230, a beam indication component 1235, a report parameter component 1240, a first report component 1245, a second report component 1250, a parameter recommendation component 1255, or any combination thereof. Each of these components may communicate, directly or indirectly, with one another (e.g., via one or more buses) which may include communications within a protocol layer of a protocol stack, communications associated with a logical channel of a protocol stack (e.g., between protocol layers of a protocol stack, within a device, component, or virtualized component associated with a network entity 105, between devices, components, or virtualized components associated with a network entity 105), or any combination thereof.

The communications manager 1220 may support wireless communications at a network entity in accordance with examples as disclosed herein. The threshold indication component 1225 is capable of, configured to, or operable to support a means for outputting control information that indicates a confidence level threshold for beam reporting. The reference signal set component 1230 is capable of, configured to, or operable to support a means for outputting a set of reference signals associated with a set of beams used for wireless communication at the network entity, where each beam of the set of beams corresponds to a respective beam index. The beam indication component 1235 is capable of, configured to, or operable to support a means for obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

In some examples, the report parameter component 1240 is capable of, configured to, or operable to support a means for communicating an indication of an update for at least one parameter associated with the report based on the quantity of beam indices included in the subset of beam indices for the report being different from a previous quantity of beam indices included in the subset of beam indices for a previous report.

In some examples, to support communicating the indication, the report parameter component 1240 is capable of, configured to, or operable to support a means for obtaining the indication of the update for the at least one parameter, the indication being included with the report and in a MAC-CE or UCI.

In some examples, to support communicating the indication, the report parameter component 1240 is capable of, configured to, or operable to support a means for outputting the indication of the update for the at least one parameter, the indication being included in a MAC-CE or DCI. In some examples, the parameter recommendation component 1255 is capable of, configured to, or operable to support a means for obtaining a recommendation for the update of the at least one parameter, where the update is based on the recommendation.

In some examples, the at least one parameter includes a payload size, a payload structure, a report quantization level, a threshold quantity of beam indices, or any combination thereof. In some examples, a quantization level used to indicate the subset of beam indices and the corresponding confidence value for each of the subset of beam indices is variable and is based on the quantity of beam indices included in the subset of beam indices.

In some examples, the quantity of beam indices included in the report is less than a total quantity of the subset of confidence values collectively satisfying the confidence level threshold. In some examples, a remainder of the total quantity not included in the report is included in a MAC-CE. In some examples, the confidence values included in the report are greater in value than the confidence values for each of the remainder of the total quantity not included in the report.

In some examples, the quantity of beam indices included in the report is less than a total quantity of the subset of confidence values collectively satisfying the confidence level threshold. In some examples, a remainder of the total quantity not included in the report is not transmitted.

In some examples, the report includes a set of multiple fields for indicating the subset of beam indices. In some examples, content of at least one field of the set of multiple fields indicates a null value based on the quantity of beam indices included in the subset of beam indices being less than a threshold quantity of beam indices associated with the report. In some examples, the report indicates a quantity of beams associated with the report.

In some examples, the report parameter component 1240 is capable of, configured to, or operable to support a means for obtaining an indication of an update for at least one parameter associated with the report based on a quantity of beam indices expected to be included in the subset of beam indices for a future report being different from the quantity of beam indices included in the subset of beam indices for the report.

In some examples, to support obtaining the indication, the first report component 1245 is capable of, configured to, or operable to support a means for obtaining, in a first part of the report, the indication of the update for the at least one parameter. In some examples, to support obtaining the indication, the second report component 1250 is capable of, configured to, or operable to support a means for obtaining, in a second part of the report, information that indicates the subset of beam indices and the corresponding confidence value for each of the subset of beam indices.

In some examples, the report indicates a corresponding received power metric for each of the subset of beam indices, the subset of received power metrics based on one or more measurements of a subset the set of reference signals associated with the subset of the set of beams.

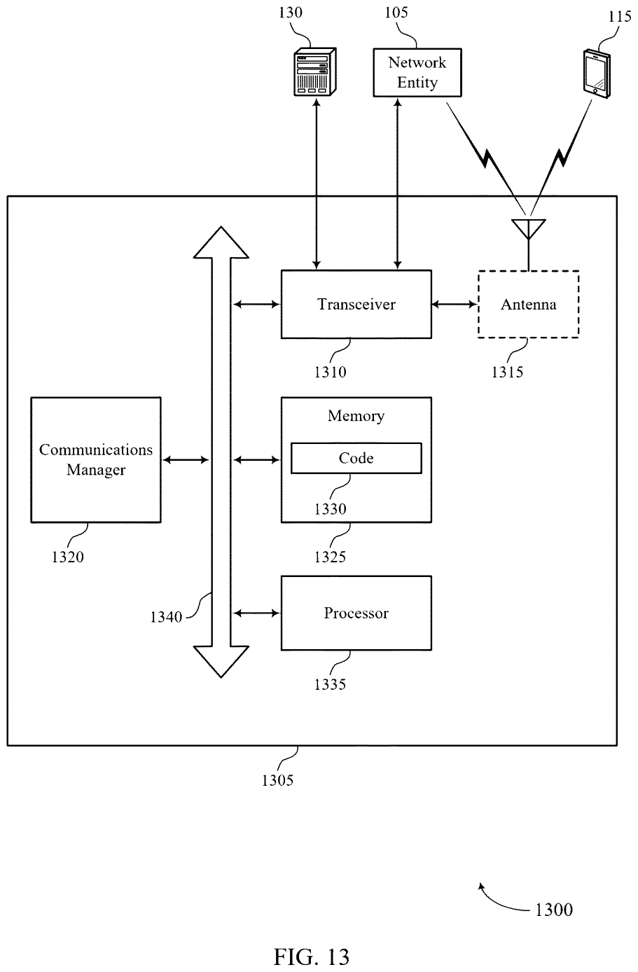

FIG. 13 shows a diagram of a system 1300 including a device 1305 that supports adaptive CSI reporting for predictive beam management in accordance with one or more aspects of the present disclosure. The device 1305 may be an example of or include the components of a device 1005, a device 1105, or a network entity 105 as described herein. The device 1305 may communicate with one or more network entities 105, one or more UEs 115, or any combination thereof, which may include communications over one or more wired interfaces, over one or more wireless interfaces, or any combination thereof. The device 1305 may include components that support outputting and obtaining communications, such as a communications manager 1320, a transceiver 1310, an antenna 1315, a memory 1325, code 1330, and a processor 1335. These components may be in electronic communication or otherwise coupled (e.g., operatively, communicatively, functionally, electronically, electrically) via one or more buses (e.g., a bus 1340).

The transceiver 1310 may support bi-directional communications via wired links, wireless links, or both as described herein. In some examples, the transceiver 1310 may include a wired transceiver and may communicate bi-directionally with another wired transceiver. Additionally, or alternatively, in some examples, the transceiver 1310 may include a wireless transceiver and may communicate bi-directionally with another wireless transceiver. In some examples, the device 1305 may include one or more antennas 1315, which may be capable of transmitting or receiving wireless transmissions (e.g., concurrently). The transceiver 1310 may also include a modem to modulate signals, to provide the modulated signals for transmission (e.g., by one or more antennas 1315, by a wired transmitter), to receive modulated signals (e.g., from one or more antennas 1315, from a wired receiver), and to demodulate signals. In some implementations, the transceiver 1310 may include one or more interfaces, such as one or more interfaces coupled with the one or more antennas 1315 that are configured to support various receiving or obtaining operations, or one or more interfaces coupled with the one or more antennas 1315 that are configured to support various transmitting or outputting operations, or a combination thereof. In some implementations, the transceiver 1310 may include or be configured for coupling with one or more processors or memory components that are operable to perform or support operations based on received or obtained information or signals, or to generate information or other signals for transmission or other outputting, or any combination thereof. In some implementations, the transceiver 1310, or the transceiver 1310 and the one or more antennas 1315, or the transceiver 1310 and the one or more antennas 1315 and one or more processors or memory components (for example, the processor 1335, or the memory 1325, or both), may be included in a chip or chip assembly that is installed in the device 1305. In some examples, the transceiver may be operable to support communications via one or more communications links (e.g., a communication link 125, a backhaul communication link 120, a midhaul communication link 162, a fronthaul communication link 168).

The memory 1325 may include RAM and ROM. The memory 1325 may store computer-readable, computer-executable code 1330 including instructions that, when executed by the processor 1335, cause the device 1305 to perform various functions described herein. The code 1330 may be stored in a non-transitory computer-readable medium such as system memory or another type of memory. In some cases, the code 1330 may not be directly executable by the processor 1335 but may cause a computer (e.g., when compiled and executed) to perform functions described herein. In some cases, the memory 1325 may contain, among other things, a BIOS which may control basic hardware or software operation such as the interaction with peripheral components or devices.

The processor 1335 may include an intelligent hardware device (e.g., a general-purpose processor, a DSP, an ASIC, a CPU, an FPGA, a microcontroller, a programmable logic device, discrete gate or transistor logic, a discrete hardware component, or any combination thereof). In some cases, the processor 1335 may be configured to operate a memory array using a memory controller. In some other cases, a memory controller may be integrated into the processor 1335. The processor 1335 may be configured to execute computer-readable instructions stored in a memory (e.g., the memory 1325) to cause the device 1305 to perform various functions (e.g., functions or tasks supporting adaptive CSI reporting for predictive beam management). For example, the device 1305 or a component of the device 1305 may include a processor 1335 and memory 1325 coupled with the processor 1335, the processor 1335 and memory 1325 configured to perform various functions described herein. The processor 1335 may be an example of a cloud-computing platform (e.g., one or more physical nodes and supporting software such as operating systems, virtual machines, or container instances) that may host the functions (e.g., by executing code 1330) to perform the functions of the device 1305. The processor 1335 may be any one or more suitable processors capable of executing scripts or instructions of one or more software programs stored in the device 1305 (such as within the memory 1325). In some implementations, the processor 1335 may be a component of a processing system. A processing system may generally refer to a system or series of machines or components that receives inputs and processes the inputs to produce a set of outputs (which may be passed to other systems or components of, for example, the device 1305). For example, a processing system of the device 1305 may refer to a system including the various other components or subcomponents of the device 1305, such as the processor 1335, or the transceiver 1310, or the communications manager 1320, or other components or combinations of components of the device 1305. The processing system of the device 1305 may interface with other components of the device 1305, and may process information received from other components (such as inputs or signals) or output information to other components. For example, a chip or modem of the device 1305 may include a processing system and one or more interfaces to output information, or to obtain information, or both. The one or more interfaces may be implemented as or otherwise include a first interface configured to output information and a second interface configured to obtain information, or a same interface configured to output information and to obtain information, among other implementations. In some implementations, the one or more interfaces may refer to an interface between the processing system of the chip or modem and a transmitter, such that the device 1305 may transmit information output from the chip or modem. Additionally, or alternatively, in some implementations, the one or more interfaces may refer to an interface between the processing system of the chip or modem and a receiver, such that the device 1305 may obtain information or signal inputs, and the information may be passed to the processing system. A person having ordinary skill in the art will readily recognize that a first interface also may obtain information or signal inputs, and a second interface also may output information or signal outputs.

In some examples, a bus 1340 may support communications of (e.g., within) a protocol layer of a protocol stack. In some examples, a bus 1340 may support communications associated with a logical channel of a protocol stack (e.g., between protocol layers of a protocol stack), which may include communications performed within a component of the device 1305, or between different components of the device 1305 that may be co-located or located in different locations (e.g., where the device 1305 may refer to a system in which one or more of the communications manager 1320, the transceiver 1310, the memory 1325, the code 1330, and the processor 1335 may be located in one of the different components or divided between different components).

In some examples, the communications manager 1320 may manage aspects of communications with a core network 130 (e.g., via one or more wired or wireless backhaul links). For example, the communications manager 1320 may manage the transfer of data communications for client devices, such as one or more UEs 115. In some examples, the communications manager 1320 may manage communications with other network entities 105, and may include a controller or scheduler for controlling communications with UEs 115 in cooperation with other network entities 105. In some examples, the communications manager 1320 may support an X2 interface within an LTE/LTE-A wireless communications network technology to provide communication between network entities 105.

The communications manager 1320 may support wireless communications at a network entity (e.g., the device 1305) in accordance with examples as disclosed herein. For example, the communications manager 1320 is capable of, configured to, or operable to support a means for outputting control information that indicating a confidence level threshold for beam reporting. The communications manager 1320 is capable of, configured to, or operable to support a means for outputting a set of reference signals associated with a set of beams used for wireless communication at the network entity, where each beam of the set of beams corresponds to a respective beam index. The communications manager 1320 is capable of, configured to, or operable to support a means for obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold.

By including or configuring the communications manager 1320 in accordance with examples as described herein, the device 1305 may support techniques for improved communication reliability, reduced latency, improved user experience related to reduced processing, more efficient utilization of communication resources, and improved utilization of processing capability.

In some examples, the communications manager 1320 may be configured to perform various operations (e.g., receiving, obtaining, monitoring, outputting, transmitting) using or otherwise in cooperation with the transceiver 1310, the one or more antennas 1315 (e.g., where applicable), or any combination thereof. Although the communications manager 1320 is illustrated as a separate component, in some examples, one or more functions described with reference to the communications manager 1320 may be supported by or performed by the transceiver 1310, the processor 1335, the memory 1325, the code 1330, or any combination thereof. For example, the code 1330 may include instructions executable by the processor 1335 to cause the device 1305 to perform various aspects of adaptive CSI reporting for predictive beam management as described herein, or the processor 1335 and the memory 1325 may be otherwise configured to perform or support such operations.

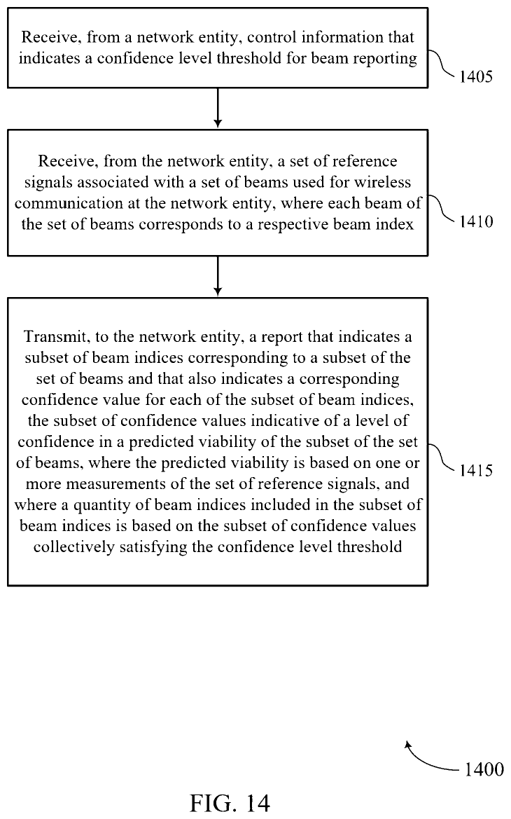

FIG. 14 shows a flowchart illustrating a method 1400 that supports adaptive CSI reporting for predictive beam management in accordance with aspects of the present disclosure. The operations of the method 1400 may be implemented by a UE or its components as described herein. For example, the operations of the method 1400 may be performed by a UE 115 as described with reference to FIGS. 1 through 9. In some examples, a UE may execute a set of instructions to control the functional elements of the wireless UE to perform the described functions. Additionally, or alternatively, the wireless UE may perform aspects of the described functions using special-purpose hardware.

At 1405, the method may include receiving, from a network entity, control information that indicates a confidence level threshold for beam reporting. The operations of 1405 may be performed in accordance with examples as disclosed herein. In some examples, aspects of the operations of 1405 may be performed by a confidence threshold component 825 as described with reference to FIG. 8.

At 1410, the method may include receiving, from the network entity, a set of reference signals associated with a set of beams used for wireless communication at the network entity, where each beam of the set of beams corresponds to a respective beam index. The operations of 1410 may be performed in accordance with examples as disclosed herein. In some examples, aspects of the operations of 1410 may be performed by a reference signal component 830 as described with reference to FIG. 8.

At 1415, the method may include transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold. The operations of 1415 may be performed in accordance with examples as disclosed herein. In some examples, aspects of the operations of 1415 may be performed by a report component 835 as described with reference to FIG. 8.

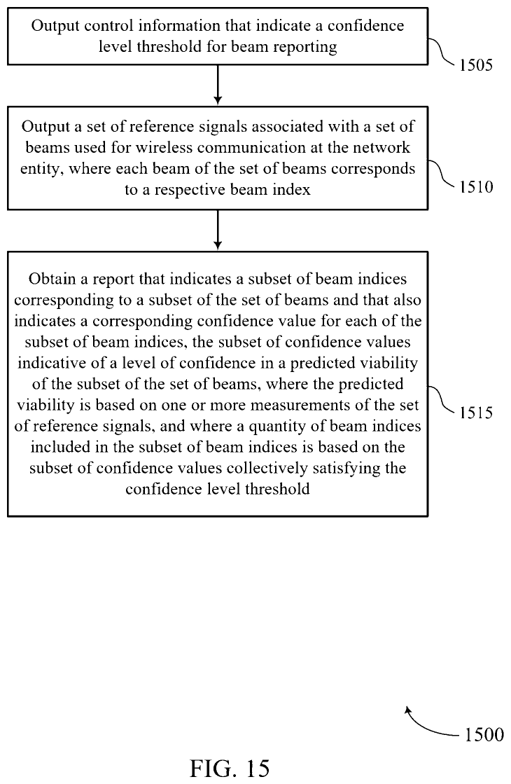

FIG. 15 shows a flowchart illustrating a method 1500 that supports adaptive CSI reporting for predictive beam management in accordance with aspects of the present disclosure. The operations of the method 1500 may be implemented by a network entity or its components as described herein. For example, the operations of the method 1500 may be performed by a network entity as described with reference to FIGS. 1 through 5 and 10 through 13. In some examples, a network entity may execute a set of instructions to control the functional elements of the wireless network entity to perform the described functions. Additionally, or alternatively, the wireless network entity may perform aspects of the described functions using special-purpose hardware.

At 1505, the method may include outputting control information that indicates a confidence level threshold for beam reporting. The operations of 1505 may be performed in accordance with examples as disclosed herein. In some examples, aspects of the operations of 1505 may be performed by a threshold indication component 1225 as described with reference to FIG. 12.

At 1510, the method may include outputting a set of reference signals associated with a set of beams used for wireless communication at the network entity, where each beam of the set of beams corresponds to a respective beam index. The operations of 1510 may be performed in accordance with examples as disclosed herein. In some examples, aspects of the operations of 1510 may be performed by a reference signal set component 1230 as described with reference to FIG. 12.

At 1515, the method may include obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, where the predicted viability is based on one or more measurements of the set of reference signals, and where a quantity of beam indices included in the subset of beam indices is based on the subset of confidence values collectively satisfying the confidence level threshold. The operations of 1515 may be performed in accordance with examples as disclosed herein. In some examples, aspects of the operations of 1515 may be performed by a beam indication component 1235 as described with reference to FIG. 12.

The following provides an overview of aspects of the present disclosure:

Aspect 1: A method for wireless communication by a UE, comprising: receiving, from a network entity, control information that indicates a confidence level threshold for beam reporting; receiving, from the network entity, a set of reference signals associated with a set of beams used for wireless communication at the network entity, wherein each beam of the set of beams corresponds to a respective beam index; and transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, wherein the predicted viability is based at least in part on one or more measurements of the set of reference signals, and wherein a quantity of beam indices included in the subset of beam indices is based at least in part on the subset of confidence values collectively satisfying the confidence level threshold.

Aspect 2: The method of aspect 1, further comprising: communicating, with the network entity, an indication of an update for at least one parameter associated with the report based at least in part on the quantity of beam indices included in the subset of beam indices for the report being different from a previous quantity of beam indices included in the subset of beam indices for a previous report.

Aspect 3: The method of aspect 2, wherein communicating the indication comprises: transmitting, to the network entity, the indication of the update for the at least one parameter, the indication being included with the report and in a MAC-CE or an UCI.

Aspect 4: The method of aspect 2, wherein communicating the indication comprises: receiving, from the network entity, the indication of the update for the at least one parameter, the indication being included in a MAC-CE or a DCI.

Aspect 5: The method of aspect 4, further comprising: transmitting, to the network entity, a recommendation for the update of the at least one parameter, wherein the update is based at least in part on the recommendation.

Aspect 6: The method of any of aspects 2 through 5, wherein the at least one parameter comprises a payload size, a payload structure, a report quantization level, a threshold quantity of beam indices, or any combination thereof.

Aspect 7: The method of any of aspects 1 through 6, wherein a quantization level used to indicate the subset of beam indices and the corresponding confidence value for each of the subset of beam indices is variable and is based at least in part on the quantity of beam indices included in the subset of beam indices.

Aspect 8: The method of any of aspects 1 through 7, wherein the quantity of beam indices included in the report is less than a total quantity of the subset of confidence values collectively satisfying the confidence level threshold, and a remainder of the total quantity not included in the report is included in a MAC-CE.

Aspect 9: The method of aspect 8, wherein the confidence values included in the report are greater in value than the confidence values for each of the remainder of the total quantity not included in the report.

Aspect 10: The method of any of aspects 1 through 7, wherein the quantity of beam indices included in the report is less than a total quantity of the subset of confidence values collectively satisfying the confidence level threshold, and a remainder of the total quantity not included in the report is not transmitted.

Aspect 11: The method of any of aspects 1 through 7, wherein the report includes a plurality of fields for indicating the subset of beam indices, and content of at least one field of the plurality of fields indicates a null value based at least in part on the quantity of beam indices included in the subset of beam indices being less than a threshold quantity of beam indices associated with the report.

Aspect 12: The method of any of aspects 1 through 11, wherein the report indicates a quantity of beams associated with the report.

Aspect 13: The method of any of aspects 7 through 12, further comprising: transmitting, to the network entity, an indication of an update for at least one parameter associated with the report based at least in part on a quantity of beam indices expected to be included in the subset of beam indices for a future report being different from the quantity of beam indices included in the subset of beam indices for the report.

Aspect 14: The method of aspect 13, wherein transmitting the indication comprises: transmitting, in a first part of the report, the indication of the update for the at least one parameter; and transmitting, in a second part of the report, information that indicates the subset of beam indices and the corresponding confidence value for each of the subset of beam indices.

Aspect 15: The method of any of aspects 1 through 14, wherein the report indicates a corresponding received power metric for each of the subset of beam indices, the subset of received power metrics based at least in part on one or more measurements of a subset the set of reference signals associated with the subset of the set of beams.

Aspect 16: A method for wireless communication by a network entity, comprising: outputting control information that indicates a confidence level threshold for beam reporting; outputting a set of reference signals associated with a set of beams used for wireless communication at the network entity, wherein each beam of the set of beams corresponds to a respective beam index; and obtaining a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, wherein the predicted viability is based at least in part on one or more measurements of the set of reference signals, and wherein a quantity of beam indices included in the subset of beam indices is based at least in part on the subset of confidence values collectively satisfying the confidence level threshold.

Aspect 17: The method of aspect 16, further comprising: communicating an indication of an update for at least one parameter associated with the report based at least in part on the quantity of beam indices included in the subset of beam indices for the report being different from a previous quantity of beam indices included in the subset of beam indices for a previous report.

Aspect 18: The method of aspect 17, wherein communicating the indication comprises: obtaining the indication of the update for the at least one parameter, the indication being included with the report and in a MAC-CE or a UCI.

Aspect 19: The method of aspect 17, wherein communicating the indication comprises: outputting the indication of the update for the at least one parameter, the indication being included in a MAC-CE or a DCI.

Aspect 20: The method of aspect 19, further comprising: obtaining a recommendation for the update of the at least one parameter, wherein the update is based at least in part on the recommendation.

Aspect 21: The method of any of aspects 17 through 20, wherein the at least one parameter comprises a payload size, a payload structure, a report quantization level, a threshold quantity of beam indices, or any combination thereof.

Aspect 22: The method of any of aspects 16 through 21, wherein a quantization level used to indicate the subset of beam indices and the corresponding confidence value for each of the subset of beam indices is variable and is based at least in part on the quantity of beam indices included in the subset of beam indices.

Aspect 23: The method of any of aspects 16 through 22, wherein the quantity of beam indices included in the report is less than a total quantity of the subset of confidence values collectively satisfying the confidence level threshold, and a remainder of the total quantity not included in the report is included in a MAC-CE.

Aspect 24: The method of aspect 23, wherein the confidence values included in the report are greater in value than the confidence values for each of the remainder of the total quantity not included in the report.

Aspect 25: The method of any of aspects 16 through 22, wherein the quantity of beam indices included in the report is less than a total quantity of the subset of confidence values collectively satisfying the confidence level threshold, and a remainder of the total quantity not included in the report is not transmitted.

Aspect 26: The method of any of aspects 16 through 22, wherein the report includes a plurality of fields for indicating the subset of beam indices, and content of at least one field of the plurality of fields indicates a null value based at least in part on the quantity of beam indices included in the subset of beam indices being less than a threshold quantity of beam indices associated with the report.

Aspect 27: The method of any of aspects 16 through 26, wherein the report indicates a quantity of beams associated with the report.

Aspect 28: The method of any of aspects 22 through 27, further comprising: obtaining an indication of an update for at least one parameter associated with the report based at least in part on a quantity of beam indices expected to be included in the subset of beam indices for a future report being different from the quantity of beam indices included in the subset of beam indices for the report.

Aspect 29: The method of aspect 28, wherein obtaining the indication comprises: obtaining, in a first part of the report, the indication of the update for the at least one parameter; and obtaining, in a second part of the report, information that indicates the subset of beam indices and the corresponding confidence value for each of the subset of beam indices.

Aspect 30: The method of any of aspects 16 through 29, wherein the report indicates a corresponding received power metric for each of the subset of beam indices, the subset of received power metrics based at least in part on one or more measurements of a subset the set of reference signals associated with the subset of the set of beams.

Aspect 31: A UE, comprising one or more memories storing processor-executable code; and one or more processors coupled with the one or more memories and individually or collectively operable to execute the code to cause the UE to perform a method of any of aspects 1 through 15.

Aspect 32: A UE, comprising at least one means for performing a method of any of aspects 1 through 15.

Aspect 33: A non-transitory computer-readable medium storing code for wireless communication, the code comprising instructions executable by one or more processors to perform a method of any of aspects 1 through 15.

Aspect 34: A network entity, comprising one or more memories storing processor-executable code; and one or more processors coupled with the one or more memories and individually or collectively operable to execute the code to cause the network entity to perform a method of any of aspects 16 through 30.

Aspect 35: A network entity, comprising at least one means for performing a method of any of aspects 16 through 30.

Aspect 36: A non-transitory computer-readable medium storing code for wireless communication, the code comprising instructions executable by one or more processors to perform a method of any of aspects 16 through 30.

It should be noted that the methods described herein describe possible implementations, and that the operations and the steps may be rearranged or otherwise modified and that other implementations are possible. Further, aspects from two or more of the methods may be combined.

Although aspects of an LTE, LTE-A, LTE-A Pro, or NR system may be described for purposes of example, and LTE, LTE-A, LTE-A Pro, or NR terminology may be used in much of the description, the techniques described herein are applicable beyond LTE, LTE-A, LTE-A Pro, or NR networks. For example, the described techniques may be applicable to various other wireless communications systems such as Ultra Mobile Broadband (UMB), Institute of Electrical and Electronics Engineers (IEEE) 802.11 (Wi-Fi), IEEE 802.16 (WiMAX), IEEE 802.20, Flash-OFDM, as well as other systems and radio technologies not explicitly mentioned herein.

Information and signals described herein may be represented using any of a variety of different technologies and techniques. For example, data, instructions, commands, information, signals, bits, symbols, and chips that may be referenced throughout the description may be represented by voltages, currents, electromagnetic waves, magnetic fields or particles, optical fields or particles, or any combination thereof.

The various illustrative blocks and components described in connection with the disclosure herein may be implemented or performed using a general-purpose processor, a DSP, an ASIC, a CPU, an FPGA or other programmable logic device, discrete gate or transistor logic, discrete hardware components, or any combination thereof designed to perform the functions described herein. A general-purpose processor may be a microprocessor but, in the alternative, the processor may be any processor, controller, microcontroller, or state machine. A processor may also be implemented as a combination of computing devices (e.g., a combination of a DSP and a microprocessor, multiple microprocessors, one or more microprocessors in conjunction with a DSP core, or any other such configuration).

The functions described herein may be implemented using hardware, software executed by a processor, firmware, or any combination thereof. If implemented using software executed by a processor, the functions may be stored as or transmitted using one or more instructions or code of a computer-readable medium. Other examples and implementations are within the scope of the disclosure and appended claims. For example, due to the nature of software, functions described herein may be implemented using software executed by a processor, hardware, firmware, hardwiring, or combinations of any of these. Features implementing functions may also be physically located at various positions, including being distributed such that portions of functions are implemented at different physical locations.

Computer-readable media includes both non-transitory computer storage media and communication media including any medium that facilitates transfer of a computer program from one location to another. A non-transitory storage medium may be any available medium that may be accessed by a general-purpose or special-purpose computer. By way of example, and not limitation, non-transitory computer-readable media may include RAM, ROM, electrically erasable programmable ROM (EEPROM), flash memory, compact disk (CD) ROM or other optical disk storage, magnetic disk storage or other magnetic storage devices, or any other non-transitory medium that may be used to carry or store desired program code means in the form of instructions or data structures and that may be accessed by a general-purpose or special-purpose computer, or a general-purpose or special-purpose processor. Also, any connection is properly termed a computer-readable medium. For example, if the software is transmitted from a website, server, or other remote source using a coaxial cable, fiber optic cable, twisted pair, digital subscriber line (DSL), or wireless technologies such as infrared, radio, and microwave, then the coaxial cable, fiber optic cable, twisted pair, DSL, or wireless technologies such as infrared, radio, and microwave are included in the definition of computer-readable medium. Disk and disc, as used herein, include CD, laser disc, optical disc, digital versatile disc (DVD), floppy disk and Blu-ray disc. Disks may reproduce data magnetically, and discs may reproduce data optically using lasers. Combinations of the above are also included within the scope of computer-readable media.

As used herein, including in the claims, “or” as used in a list of items (e.g., a list of items prefaced by a phrase such as “at least one of” or “one or more of”) indicates an inclusive list such that, for example, a list of at least one of A, B, or C means A or B or C or AB or AC or BC or ABC (i.e., A and B and C). Also, as used herein, the phrase “based on” shall not be construed as a reference to a closed set of conditions. For example, an example step that is described as “based on condition A” may be based on both a condition A and a condition B without departing from the scope of the present disclosure. In other words, as used herein, the phrase “based on” shall be construed in the same manner as the phrase “based at least in part on.”

The term “determine” or “determining” encompasses a variety of actions and, therefore, “determining” can include calculating, computing, processing, deriving, investigating, looking up (such as via looking up in a table, a database or another data structure), ascertaining and the like. Also, “determining” can include receiving (e.g., receiving information), accessing (e.g., accessing data stored in memory) and the like. Also, “determining” can include resolving, obtaining, selecting, choosing, establishing, and other such similar actions.

In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label, or other subsequent reference label.

The description set forth herein, in connection with the appended drawings, describes example configurations and does not represent all the examples that may be implemented or that are within the scope of the claims. The term “example” used herein means “serving as an example, instance, or illustration,” and not “preferred” or “advantageous over other examples.” The detailed description includes specific details for the purpose of providing an understanding of the described techniques. These techniques, however, may be practiced without these specific details. In some instances, known structures and devices are shown in block diagram form in order to avoid obscuring the concepts of the described examples.

The description herein is provided to enable a person having ordinary skill in the art to make or use the disclosure. Various modifications to the disclosure will be apparent to a person having ordinary skill in the art, and the generic principles defined herein may be applied to other variations without departing from the scope of the disclosure. Thus, the disclosure is not limited to the examples and designs described herein but is to be accorded the broadest scope consistent with the principles and novel features disclosed herein.

1. A user equipment (UE), comprising:
one or more memories storing processor-executable code; and
one or more processors coupled with the one or more memories and individually or collectively operable to execute the code to cause the UE to:
receive, from a network entity, control information that indicates a confidence level threshold for beam reporting;
receive, from the network entity, a set of reference signals associated with a set of beams used for wireless communication at the network entity, wherein each beam of the set of beams corresponds to a respective beam index; and
transmit, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, wherein the predicted viability is based at least in part on one or more measurements of the set of reference signals, and wherein a quantity of beam indices included in the subset of beam indices is based at least in part on the subset of confidence values collectively satisfying the confidence level threshold.

2. The UE of claim 1, wherein the one or more processors are individually or collectively further operable to execute the code to cause the UE to:
communicate, with the network entity, an indication of an update for at least one parameter associated with the report based at least in part on the quantity of beam indices included in the subset of beam indices for the report being different from a previous quantity of beam indices included in the subset of beam indices for a previous report.

3. The UE of claim 2, wherein, to communicate the indication, the one or more processors are individually or collectively operable to execute the code to cause the UE to:
transmit, to the network entity, the indication of the update for the at least one parameter, the indication being included with the report and in a medium access control-control element or an uplink control information.

4. The UE of claim 2, wherein, to communicate the indication, the one or more processors are individually or collectively operable to execute the code to cause the UE to:
receive, from the network entity, the indication of the update for the at least one parameter, the indication being included in a medium access control-control element or a downlink control information.

5. The UE of claim 4, wherein the one or more processors are individually or collectively further operable to execute the code to cause the UE to:
transmit, to the network entity, a recommendation for the update of the at least one parameter, wherein the update is based at least in part on the recommendation.

6. The UE of claim 2, wherein the at least one parameter comprises a payload size, a payload structure, a report quantization level, a threshold quantity of beam indices, or any combination thereof.

7. The UE of claim 1, wherein a quantization level used to indicate the subset of beam indices and the corresponding confidence value for each of the subset of beam indices is variable and is based at least in part on the quantity of beam indices included in the subset of beam indices.

8-11. (canceled)

12. The UE of claim 1, wherein the report indicates a quantity of beams associated with the report.

13. The UE of claim 1, wherein the one or more processors are individually or collectively further operable to execute the code to cause the UE to:
transmit, to the network entity, an indication of an update for at least one parameter associated with the report based at least in part on a quantity of beam indices expected to be included in the subset of beam indices for a future report being different from the quantity of beam indices included in the subset of beam indices for the report.

14. The UE of claim 13, wherein, to transmit the indication, the one or more processors are individually or collectively operable to execute the code to cause the UE to:
transmit, in a first part of the report, the indication of the update for the at least one parameter; and
transmit, in a second part of the report, information that indicates the subset of beam indices and the corresponding confidence value for each of the subset of beam indices.

15. The UE of claim 1, wherein the report indicates a corresponding received power metric for each of the subset of beam indices, the subset of received power metrics based at least in part on one or more measurements of a subset the set of reference signals associated with the subset of the set of beams.

16. A method for wireless communication by a user equipment (UE), comprising:
receiving, from a network entity, control information that indicates a confidence level threshold for beam reporting;
receiving, from the network entity, a set of reference signals associated with a set of beams used for wireless communication at the network entity, wherein each beam of the set of beams corresponds to a respective beam index; and
transmitting, to the network entity, a report that indicates a subset of beam indices corresponding to a subset of the set of beams and that also indicates a corresponding confidence value for each of the subset of beam indices, the subset of confidence values indicative of a level of confidence in a predicted viability of the subset of the set of beams, wherein the predicted viability is based at least in part on one or more measurements of the set of reference signals, and wherein a quantity of beam indices included in the subset of beam indices is based at least in part on the subset of confidence values collectively satisfying the confidence level threshold.

17. The method of claim 16, further comprising:
communicating, with the network entity, an indication of an update for at least one parameter associated with the report based at least in part on the quantity of beam indices included in the subset of beam indices for the report being different from a previous quantity of beam indices included in the subset of beam indices for a previous report.

18. The method of claim 17, wherein communicating the indication comprises:
transmitting, to the network entity, the indication of the update for the at least one parameter, the indication being included with the report and in a medium access control-control element or an uplink control information.

19. The method of claim 17, wherein communicating the indication comprises:
receiving, from the network entity, the indication of the update for the at least one parameter, the indication being included in a medium access control-control element or a downlink control information.

20. The method of claim 19, further comprising:
transmitting, to the network entity, a recommendation for the update of the at least one parameter, wherein the update is based at least in part on the recommendation.

21. The method of claim 17, wherein the at least one parameter comprises a payload size, a payload structure, a report quantization level, a threshold quantity of beam indices, or any combination thereof.

22. The method of claim 16, wherein a quantization level used to indicate the subset of beam indices and the corresponding confidence value for each of the subset of beam indices is variable and is based at least in part on the quantity of beam indices included in the subset of beam indices.

23-25. (canceled)

26. The method of claim 16, wherein the report includes a plurality of fields for indicating the subset of beam indices, and wherein content of at least one field of the plurality of fields indicates a null value based at least in part on the quantity of beam indices included in the subset of beam indices being less than a threshold quantity of beam indices associated with the report.

27. The method of claim 16, wherein the report indicates a quantity of beams associated with the report.

28-30. (canceled)
